(19) United States
(12) Patent Application Publication
(10) Pub. No.: US 2017/0308684 A1
(43) Pub. Date: Oct. 26, 2017

(54) SYSTEM AND METHOD FOR INFORMATION PROCESSING

(71) Applicant: FUJITSU LIMITED, Kawasaki-shi (JP)

(72) Inventor: Koji Morino, Fuji (JP)

(73) Assignee: FUJITSU LIMITED, Kawasaki-shi (JP)

(21) Appl. No.: 15/444,499

(22) Filed: Feb. 28, 2017

(30) Foreign Application Priority Data
Apr. 21, 2016 (JP) 2016-085446

(51) Int. Cl. G06F 21/10; H04L 9/08; H04L 9/12; H04L 9/14; H04L 29/06

(52) U.S. Cl. CPC G06F 21/105; H04L 9/14; H04L 63/062; H04L 9/12; H04L 9/0819; H04L 9/0816; H04L 9/0802

(57) ABSTRACT

When, for example, an information processing apparatus additionally assigns a license in an information processing system in which plural information processing apparatuses perform a license check, the information processing apparatus adds an additional license count to an assigned license count stored in an internal memory thereof, and transmits the additional license count to an information processing apparatus started first and an information processing apparatus started immediately after the information processing apparatus to which the license is additionally assigned. In the first started information processing apparatus, the additional license count is added to an assigned license count stored in an internal memory thereof. Likewise, in each of the information processing apparatuses that were started after the information processing apparatus to which the license is additionally assigned, the additional license count is added to an assigned license count stored in an internal memory thereof, in a startup order.

### CROSS-REFERENCE TO RELATED APPLICATION

This application is based upon and claims the benefit of priority of the prior Japanese Patent Application No. 2016-085446 filed on Apr. 21, 2016, the entire contents of which are incorporated herein by reference.

### FIELD

The embodiments discussed herein are related to an information processing system and an information processing method.

### BACKGROUND

In cloud computing services, a type of license agreement that is becoming more common is one that grants the number of licenses for application software based on the maximum number of concurrent users of the application software on a network. If an application is provided under such a license agreement, the application may be used by up to the number of concurrent users that matches the number of licenses granted.

In this case, the licenses are managed such that the number of concurrent users of the application on a network does not exceed the number of licenses. Therefore, the number of licenses is usually managed by a license management server dedicated to license management.

In the case where a license management server manages the number of licenses, if the license management server fails, all the license management information may be lost, and all the running servers may fail to manage the number of licenses.

In view of the above, there has been proposed a license authentication method that manages the number of licenses without using a license management server. According to the proposed method, software is installed with a management number containing information on the number of licenses. Then, upon starting the software on a computer, the computer obtains software management numbers from all the computers connected over a network. If the number of computers that have the same management number as the software to be started is less than the number of licenses, the computer permits use of the software.

See, for example, Japanese Laid-open Patent Publication No. 2004-355488.

### SUMMARY

According to one aspect of the invention, there is provided an information processing system including: a plurality of information processing apparatuses, each of the plurality of information processing apparatuses including a memory configured to store an assigned license count indicating a number of licenses that have already been assigned, and a processor; wherein the processor of one of the plurality of information processing apparatuses excluding a first started information processing apparatus in a startup order of the plurality of information processing apparatuses, the startup order being stored in the memory, is configured to: upon additionally assigning one or more licenses to the one of the information processing apparatuses, add an additional license count to an assigned license count stored in the memory of the one of the information processing apparatuses, the additional license count indicating a number of licenses that are additionally assigned, and transmit the additional license count to the first started information processing apparatus and an information processing apparatus that was started immediately after the one of the information processing apparatuses in the startup order; and upon receiving an additional license count from another of the information processing apparatuses, add the received additional license count to the assigned license count stored in the memory of the one of the information processing apparatuses, and transmit the received additional license count to the information processing apparatus that was started immediately after the one of the information processing apparatuses in the startup order; and wherein the processor of the first started information processing apparatus is configured to, upon receiving the additional license count from the one of the information processing apparatuses, add the received additional license count to an assigned license count stored in the memory of the first started information processing apparatus.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of functions of an information processing system according to a first embodiment;

FIG. 2 illustrates an exemplary hardware configuration of a computer used in a second embodiment;

FIG. 3 is a configuration diagram illustrating a license management system according to the second embodiment;

FIG. 4 illustrates an exemplary configuration of server link information;

FIG. 5 illustrates an exemplary configuration of license management information;

FIG. 6 is a diagram of a processing sequence of license information illustrating the flow of a license addition process performed when newly starting software;

FIG. 7 is an explanatory diagram illustrating the flow of a license addition process performed when newly starting software;

FIG. 8 is a diagram of a processing sequence of license information illustrating the flow of a license update process performed when newly starting software;

FIG. 9 is an explanatory diagram illustrating the flow of a license update process performed when newly starting software;

FIG. 10 is a diagram of a processing sequence of license information illustrating the flow of a license removal process performed when shutting down software;

FIG. 11 is an explanatory diagram illustrating the flow of a license removal process performed when shutting down software;

FIG. 12 is a flowchart illustrating the flow of processing of server link information performed when newly adding a server;

FIG. 13 illustrates an example of default settings of server link information for a Head server;

FIG. 14 is an explanatory diagram illustrating the flow of a server link information update process performed when newly adding a server;

FIG. 15 is a flowchart illustrating the flow of processing of server link information performed when shutting down a running server;

FIG. 16 is an explanatory diagram illustrating the flow of a server link information update process performed when shutting down a running server;

FIG. 17 is a flowchart illustrating the flow of a server link restoration process performed when an intermediate server other than a Head server and a Tail server has failed;

FIG. 18 is an explanatory diagram illustrating the flow of a server link restoration process performed when an intermediate server other than a Head server and a Tail server has failed;

FIG. 19 is an explanatory diagram illustrating the flow of a license information restoration process performed when an intermediate server other than a Head server and a Tail server has failed;

FIG. 20 is a processing sequence diagram illustrating the flow of a process performed when a Tail server has failed;

FIG. 21 is an explanatory diagram illustrating the flow of a process performed when a Tail server has failed;

FIG. 22 is a processing sequence diagram illustrating the flow of a process performed when a Head server has failed;

FIG. 23 is a processing sequence diagram illustrating the flow of a process performed when both a Head server and a Tail server have failed;

FIG. 24 is an explanatory diagram illustrating the flow of a process performed when both a Head server and a Tail server have failed;

FIGS. 25 and 26 are processing sequence diagrams illustrating the flow of updating server link information in a cloud environment;

FIG. 27 is a flowchart illustrating the flow of updating server link information in a cloud environment;

FIG. 28 is an explanatory diagram illustrating an example of image deployment in a cloud environment in the case where a Head server is present;

FIG. 29 is an explanatory diagram illustrating an example of image deployment in a cloud environment in the case where a Head server has failed and a running server is present;

FIG. 30 is an explanatory diagram illustrating an example of image deployment in a cloud environment in the case where a Head server is not present;

FIG. 31 is an explanatory diagram illustrating an example where, during image deployment in a cloud environment in which a Head server and a running server are present, the Head server has failed; and

FIG. 32 is an explanatory diagram illustrating an example of image deployment in a cloud environment in the case where a Head server and a running server are present.

### DESCRIPTION OF EMBODIMENTS

Since license information is stored in each computer that attempts to use software, and since the number of computers using the same software in a system is checked, there is no need to use a license management server. This prevents a failure of a certain computer from causing a failure of the entire license management. On the other hand, it is needed to obtain license information such as the management number from all the computers in the system. That is, as the number of computers on the network increases, the time taken to obtain the license information increases. Accordingly, the time needed to complete a license check increases, and the time needed for newly started software to be ready for use increases.

Several embodiments will be described below with reference to the accompanying drawings, wherein like reference numerals refer to like elements throughout. Features of certain embodiments may be combined with features of other embodiments as long as no inconsistency arises.

### (a) First Embodiment

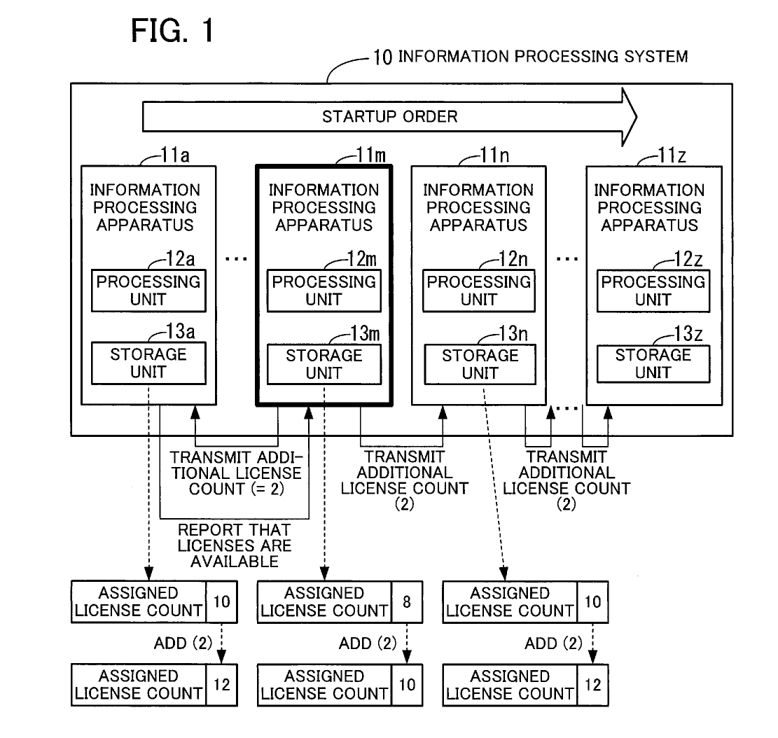

FIG. 1 illustrates an example of functions of an information processing system according to a first embodiment. An information processing system 10 includes a plurality of information processing apparatuses 11a to 11z. In FIG. 1, the plurality of information processing apparatuses 11a to 11z are arranged in order of startup. The information processing apparatuses 11a to 11z include processing units 12a to 12z and storage units 13a to 13z, respectively.

When any of the information processing apparatuses 11a to 11z additionally assigns thereto one or more licenses or receives the number of licenses that are additionally assigned from any of the other information processing apparatuses 11a to 11z, the corresponding one of the processing units 12a to 12z updates the number of licenses that have already been assigned. Each of the storage units 13a to 13z stores the number of assigned software licenses. Each of the storage units 13a to 13z also stores the number of licenses that are owned.

In the information processing system 10 having the configuration described above, the information processing apparatus 11a that was started first serves as an apparatus representing the information processing system 10, and manages the number of licenses in the entire system. Therefore, when each of the other information processing apparatuses 11b to 11z (the information processing apparatus 11b is the second started apparatus) additionally assigns thereto one or more licenses, each of the other information processing apparatuses 11b to 11z always transmits to the representative information processing apparatus 11a the number of licenses that are additionally assigned.

The following describes the operations performed when the m-th started information processing apparatus 11m newly adds thereto two licenses for software, for example. First, in the information processing apparatus 11m, the processing unit 12m transmits the number of licenses that are additionally assigned (hereinafter referred to as a “additional license count”) “2” to the information processing apparatus 11a.

In the information processing apparatus 11a, the storage unit 13a stores the number of licenses that have already been assigned (hereinafter referred to as an “assigned license count”). In the example of FIG. 1, the storage unit 13a stores “10” as the assigned license count. Upon receiving the additional license count “2” from the information processing apparatus 11m, the processing unit 12a of the information processing apparatus 11a adds the received additional license count to the assigned license count stored in the storage unit 13a. In the example of FIG. 1, the processing unit 12a adds the received additional license count “2” to the assigned license count “10” to update the assigned license count in the storage unit 13a to “12”. If the updated assigned license count is equal to or less than the owned license count, the processing unit 12a notifies the information processing apparatus 11m that there are available licenses.

In the information processing apparatus 11m having been notified that there are available licenses, the processing unit 12m adds the additional license count to the assigned license count stored in the storage unit 13m. In the example of FIG. 1, the processing unit 12m adds the additional license count “2” to the assigned license count “8” to update the assigned license count in the storage unit 13m to “10”. Then, the processing unit 12m transmits the additional license count “2” to the information processing apparatus 11n that was started immediately after the information processing apparatus 11m.

Then, in the information processing apparatus 11n having received the additional license count “2” from the information processing apparatus 11m, the processing unit 12n adds the additional license count to the assigned license count stored in the storage unit 13n. In the example of FIG. 1, the processing unit 12n adds the additional license count “2” to the assigned license count “10” to update the assigned license count in the storage unit 13n to “12”. Then, the processing unit 12n transmits the additional license count “2” to an information processing apparatus that was started immediately after the information processing apparatus 11n. This operation of transmitting the additional license count from a current information processing apparatus to an information processing apparatus that was started immediately after the current information processing apparatus is repeated until the information processing apparatus 11z that was started last in the startup order performs the assigned license count update process.

By performing this processing, the total assigned license count of the entire system is stored in the information processing apparatus 11a at the top and the information processing apparatus 11z at the end of the information processing apparatuses 11a to 11z that are linked in the startup order. The assigned license count stored in each of the other information processing apparatuses 11b to 11y (the information processing apparatus 11y is the second last started apparatus) indicates the cumulative number of licenses assigned to the information processing apparatus having additionally assigned licenses thereto to that information processing apparatus.

In the information processing system 10, when the information processing apparatus 11m newly starts software, the information processing apparatus 11m only needs to update the assigned license count in the information processing apparatus 11m, and transmit the additional license count to the information processing apparatus 11a at the top and the information processing apparatus 11n that was started immediately after the information processing apparatus 11m. This allows the information processing system 10 to perform a license check in a short time when newly starting software, and quickly start the software.

Further, in the information processing system 10, the information processing apparatus 11a at the top in the startup order is assigned to manage licenses. Accordingly, if the information processing apparatus 11a having been managing licenses fails, the second information processing apparatus 11b in the startup order takes over the license management process. Thus, it is possible to uniquely determine an information processing apparatus that takes over the license management process, and therefore to quickly take over the license management process. Further, even if the information processing apparatus 11a at the top fails, the information processing apparatus 11z at the end stores the total assigned license count of the entire system. Accordingly, the information processing apparatus 11z transmits the total assigned license count to the second information processing apparatus 11b in the startup order, thereby allowing the information processing apparatus 11b to quickly start license management.

Note that the processing units 12a to 12z included in the respective information processing apparatuses 11a to 11z are processors included in the respective information processing apparatuses 11a to 11z. Also, the storage units 13a to 13z included in the respective information processing apparatuses 11a to 11z are memories or storage devices included in the respective information processing apparatuses 11a to 11z.

### (b) Second Embodiment

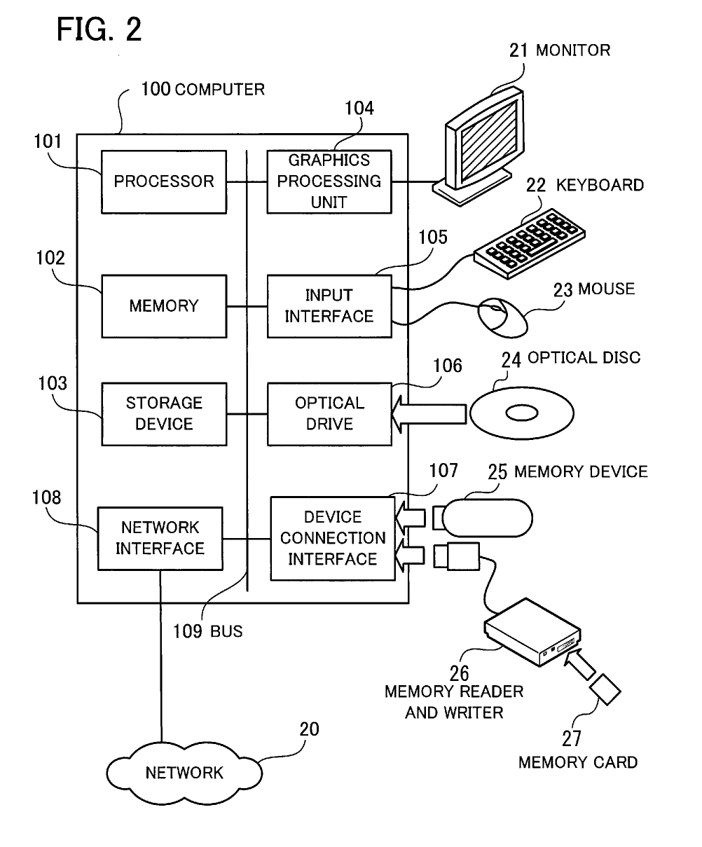

FIG. 2 illustrates an exemplary hardware configuration of a computer 100 used in a second embodiment. The entire operation of the computer 100 is controlled by a processor 101. A memory 102 and a plurality of peripheral devices are connected to the processor 101 via a bus 109. The processor 101 may be a multiprocessor. Examples of the processor 101 include a central processing unit (CPU), a micro processing unit (MPU), and a digital signal processor (DSP). At least a part of functions implemented by a program executed by the processor 101 may be implemented by using electronic circuits such as an application-specific integrated circuit (ASIC), a programmable logic device (PLD), and the like.

The memory 102 is used as a primary storage device of the computer 100. The memory 102 temporarily stores at least part of the operating system (OS) program and application programs that are executed by the processor 101. The memory 102 also stores various types of data used for the processing performed by the processor 101. Examples of the memory 102 include a volatile semiconductor storage device such as a random access memory (RAM) and the like.

The peripheral devices connected to the bus 109 include a storage device 103, a graphics processing unit 104, an input interface 105, an optical drive 106, a device connection interface 107, and a network interface 108.

The storage device 103 magnetically writes data to and reads data from its internal disk. The storage device 103 is used as a secondary storage device of the computer 100. The storage device 103 stores the OS program, application programs, and various types of data. The storage device 103 may be a hard disk drive (HDD) or a solid state drive (SSD), for example.

A monitor 21 is connected to the graphics processing unit 104. The graphics processing unit 104 displays an image on the screen of the monitor 21 in accordance with an instruction from the processor 101. Examples of the monitor 21 include a display device using a cathode ray tube (CRT), a liquid crystal display device, and the like.

A keyboard 22 and a mouse 23 are connected to the input interface 105. The input interface 105 receives signals from the keyboard 22 and the mouse 23, and transmits the received signals to the processor 101. The mouse 23 is an example of a pointing device, and other types of pointing devices may also be used. Examples of other types of pointing devices include a touch panel, a tablet, a touch pad, a track ball, and the like.

The optical drive 106 reads data from an optical disc 24 by using laser beams or the like. The optical disc 24 is a portable storage medium and stores data such that the data may be read through optical reflection. Examples of the optical disc 24 include digital versatile disc (DVD), DVD-RAM, compact disc read only memory (CD-ROM), CD-Recordable (CD-R), CD-Rewritable (CD-RW), and the like.

The device connection interface 107 is a communication interface that connects peripheral devices to the computer 100. For example, a memory device 25 and a memory reader and writer 26 may be connected to the device connection interface 107. The memory device 25 is a storage medium having a function to communicate with the device connection interface 107. The memory reader and writer 26 is a device that writes data to and reads data from a memory card 27. The memory card 27 is a card-type storage medium.

The network interface 108 is connected to a network 20. The network interface 108 exchanges data with other computers or communication apparatuses via the network 20.

With the hardware configuration described above, it is possible to provide the processing functions of the second embodiment. Note that the plurality of information processing apparatuses 11a to 11z of the information processing system 10 of the first embodiment may be implemented by a plurality of virtual servers that run in a virtual environment created by a physical server that is implemented by the computer 100. Accordingly, the processing units 12a to 12z of the plurality of information processing apparatuses 11a to 11z of the information processing system 10 of the first embodiment correspond to the processor 101, and the storage units 13a to 13z correspond to the memory 102 and the storage device 103.

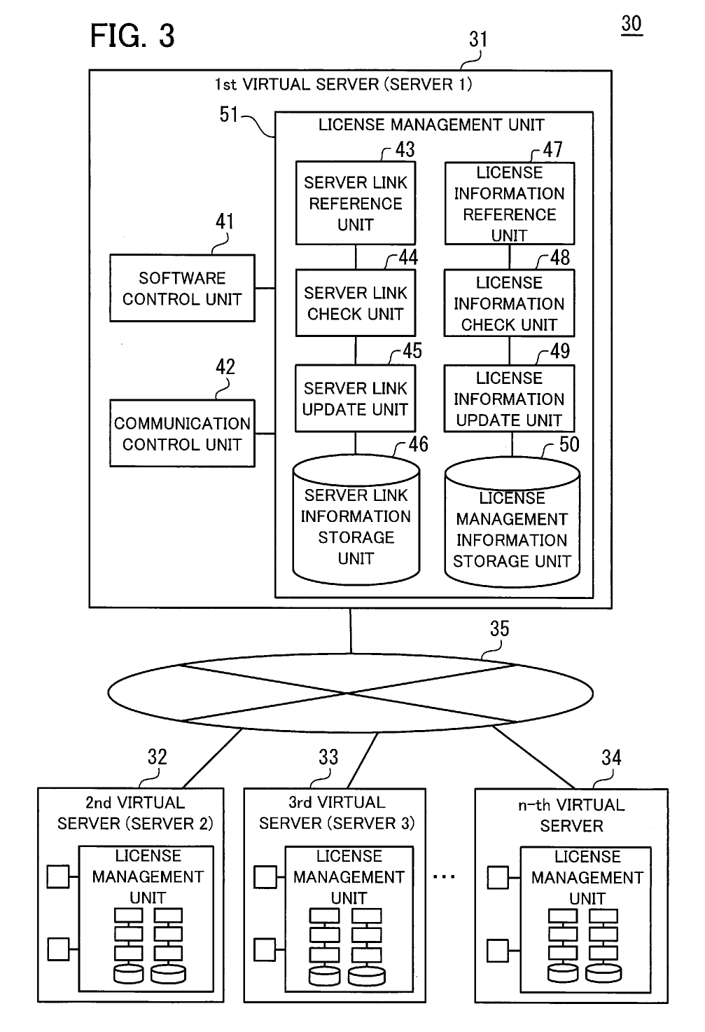

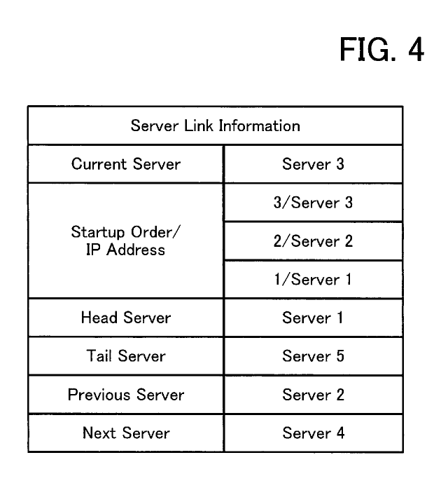

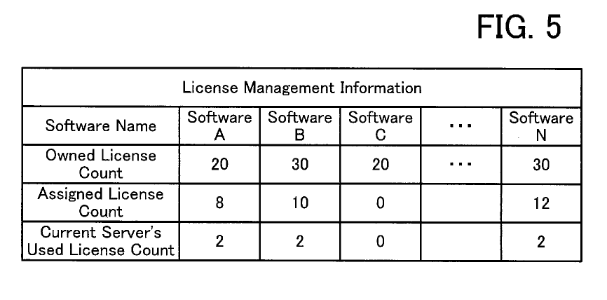

FIG. 3 is a configuration diagram illustrating a license management system according to the second embodiment; FIG. 4 illustrates an exemplary configuration of server link information; and FIG. 5 illustrates an exemplary configuration of license management information. A license management system 30 includes a plurality of virtual servers, namely, first to n-th virtual servers 31 to 34. The first virtual server 31 (hereinafter also referred to as a “server 1”) is connected to the second virtual server 32 (hereinafter also referred to as a “server 2”), the third virtual server 33 (hereinafter also referred to as a “server 3”), . . . , and the n-th virtual server 34 via a network 35.

The first to n-th virtual servers 31 to 34 have the same configuration. Accordingly, the configuration of only the first virtual server 31 out of the first to n-th virtual servers 31 to 34 will be described herein.

The first virtual server 31 includes a software control unit 41 that controls startup and shutdown of software, a communication control unit 42 that communicates with the other virtual servers via the network 35 in the virtual environment, and a license management unit 51 that performs license management. The communication control unit 42 is also connected to the network interface 108 of the computer 100 serving as a physical server.

The license management unit 51 has two functions, that is, a server link function that manages server link information indicating the link between servers, and a license management function that manages license information of software.

The server link function includes a server link reference unit 43, a server link check unit 44, a server link update unit 45, and a server link information storage unit 46. The server link information managed by the server link function is stored in the server link information storage unit 46, and includes information illustrated in FIG. 4, for example. More specifically, the server link information includes the following information: Current Server, Startup Order/IP Address, Head Server, Tail Server, Previous Server, and Next Server. The Current Server information is server information indicating the address (IP address) of a deployed current server. The Startup Order/IP Address information is server information indicating the order in which the servers were started and the IP addresses of the servers. The Head Server information is server information indicating the address (IP address) of the first started server. The Tail Server information is server information indicating the address (IP address) of the last started server. The Previous Server information is server information indicating the address (IP address) of the server that was started immediately before the current server. The Next Server information is server information indicating the address (IP address) of the server that was started immediately after the current server.

According to the server link information of FIG. 4, the Current Server information indicates that the current server is the server 3, and the Startup Order/IP Address information indicates that the server 1 and the server 2 were started in this order before the server 3. The Head Server information indicates that the first started server is the server 1, and the Tail server information indicates that the last started server is the server 5 and that five servers have been started. Further, the Previous Server information and the Next Server information indicate that the servers started before and after the current server are the server 2 and the server 4.

In the server link function of the license management unit 51, the server link reference unit 43 refers to the server information such as Head Server, Tail Server, and so on when performing a license check. The server link check unit 44 checks each piece of the server link information stored in the server link information storage unit 46. The server link update unit 45 updates the server link information when a change is made to the server link information. The server link information storage unit 46 stores the server link information indicating the link between servers.

Meanwhile, the license management function of the license management unit 51 includes a license information reference unit 47, a license information check unit 48, a license information update unit 49, and a license management information storage unit 50. The license information reference unit 47 refers to information on owned licenses, assigned licenses, and so on of software when starting the software. The license information check unit 48 checks information on owned licenses, assigned licenses, and so on of software when starting the software. The license information update unit 49 updates information on owned licenses, assigned licenses, and so on of software when starting the software. The license management information storage unit 50 manages information on owned licenses, assigned licenses, and so on of software, and stores the information on owned licenses, assigned licenses, and so on.

The license management information stored in the license management information storage unit 50 and managed by the license management function includes information illustrated in FIG. 5, for example. More specifically, the license management information includes the following information on a per-software basis: software name, the owned license count, the assigned license count, and the Current server's used license count. In the license management information, the software name indicates the name of software under management. The owned license count indicates the number of licenses for the software under management that are owned. The assigned license count indicates the number of licenses for the software under management that have already been assigned (the processor assigned count). The Current server's used license count indicates the number of licenses for the software under management that are used by the current server.

Hereinafter a description will be given of various processes involved in license management in the license management system. First, a description will be given of processes of adding and updating used licenses when newly starting software, and a process of removing used licenses.

(License Management Process Performed when Newly Starting Software)

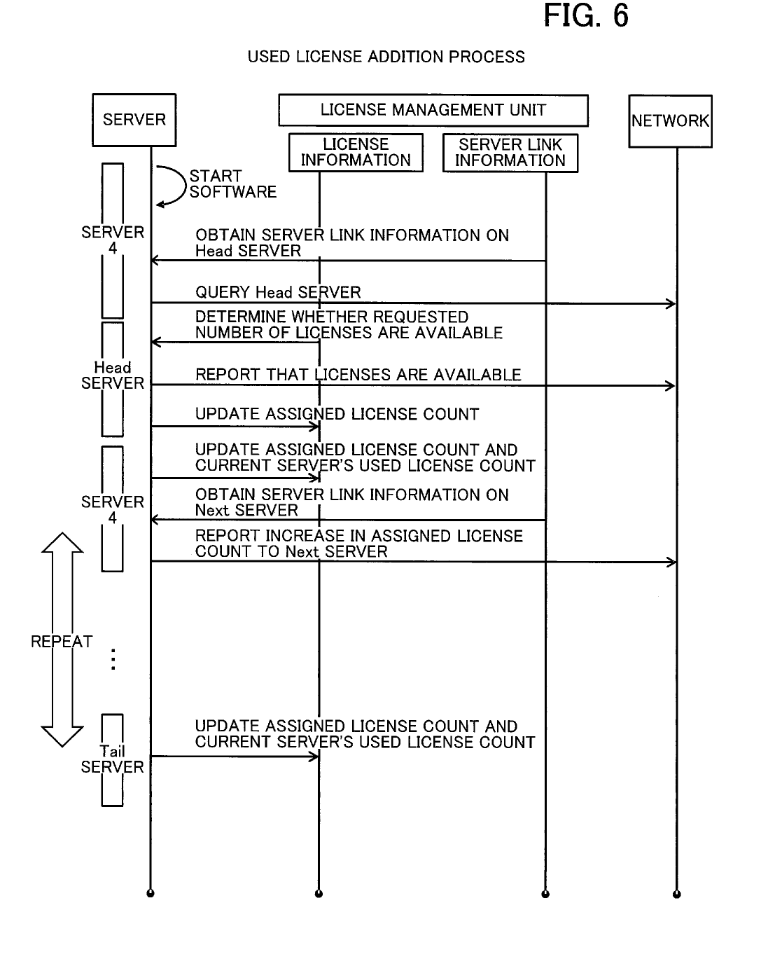

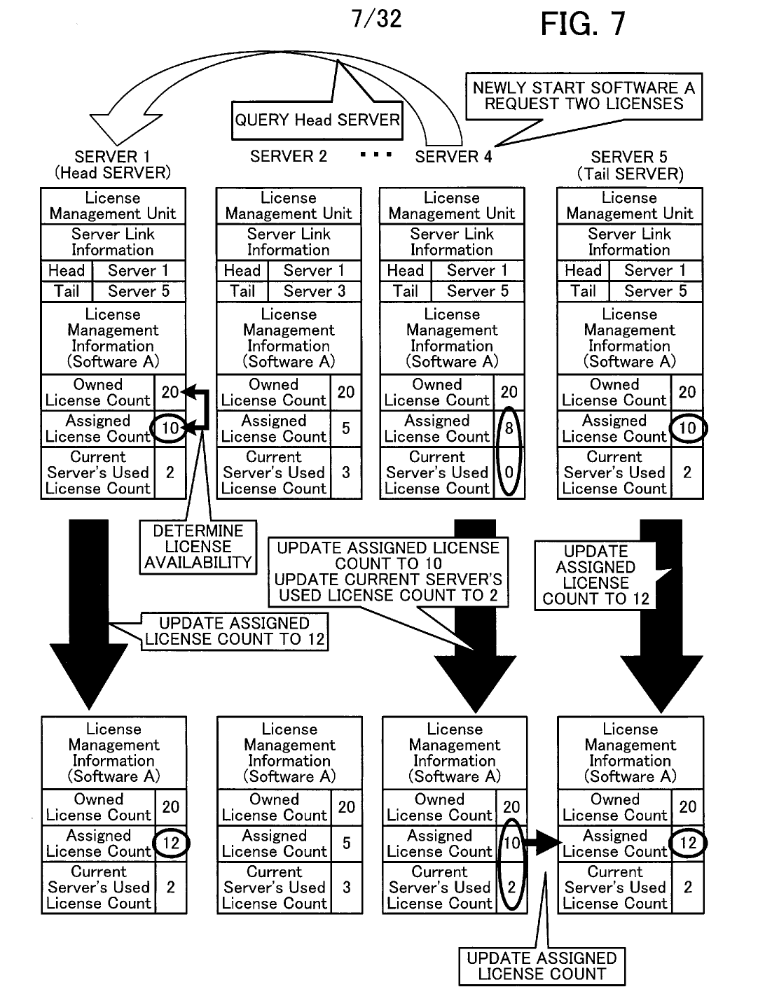

FIG. 6 is a diagram of a processing sequence of license information illustrating the flow of a license addition process performed when newly starting software, and FIG. 7 is an explanatory diagram illustrating the flow of a license addition process performed when newly starting software. In FIG. 6, “SERVER” at the left represents all the servers from the Head server to the Tail server, and “LICENSE MANAGEMENT UNIT” at the center represents the license management units of the servers.

First, a description will be given of an example where servers 1 to 5 are started as a license management system in this order as illustrated in FIG. 7. In this case, the first started server 1 becomes the Head server, and the last started server 5 becomes the Tail server. In this example, the server 4 newly starts software A. Further, in the license management system, the owned license count of software A is “20”, the number of assigned licenses for the software A at the time of startup of the server 4 is “8”. Further, the Current server's used license count of the server 4 is “0”, and the number of licenses for the software A that is newly started by the server 4 is “2”.

The license addition process starts when the server 4 starts the software A. The server link reference unit 43 of the license management unit 51 of the server 4 obtains the address of the Head server stored in the server link information storage unit 46. Then, the server 4 notifies the Head server that the software A newly activates two licenses.

In the Head server, the owned license count of the software A stored in the license management information storage unit 50 is “20”, and the assigned license count of the software A at the present time is “10”. In the Head server having received the query about whether two licenses may be newly used from the server 4, the license information reference unit 47 first refers to the assigned license count and the Current server's used license count in the license management information storage unit 50. Then, the license information check unit 48 determines whether the requested number of licenses are available, based on the assigned license count and the Current server's used license count. In this example, the owned license count of the software A is “20”; the assigned license count is “10”; and the requested license count is “2”. Thus, even when the assigned license count is increased to “12”, the assigned license count does not reach the owned license count “20”. Accordingly, the Head server determines that the requested number of licenses, that is, two licenses are available, and reports the determination result to the server 4. Then, in the Head server, the license information update unit 49 updates the assigned license count in the license management information storage unit 50 to “12”.

Meanwhile, in the server 4 having received the determination result indicating that licenses are available, the license information update unit 49 updates the assigned license count from “8” to “10”, and updates the Current server's used license count from “0” to “2”, in the license management information storage unit 50.

Then, the license management unit 51 of the server 4 causes the server link reference unit 43 to obtain the address of the Next server stored in the server link information storage unit 46, and reports the increase in the assigned license count to the Next server.

Upon receiving the report indicating that the assigned license count is increased by “2”, the server identified as the Next server updates the assigned license count in the license management information thereof by increasing its value by “2”. In the assigned license update process, the operation of sequentially updating the assigned license count by increasing its value by “2” is repeated, starting from the server 4 that has newly started the software A and proceeding to the subsequent servers in the startup order.

Then, when the Tail server is identified as the Next server, the Tail server updates the assigned license count in the license management information thereof by increasing its value by “2”. In the example of FIG. 7, the Next server of the server 4 is the Tail server. Thus, when the assigned license count of the Tail server is updated from “10” to “12”, the used license addition process is completed.

The following describes a used license update process performed when newly starting software. When a certain server newly starts software, the license addition process described above is performed. When the software is newly added, if the assigned license count stored in the Head server exceeds the owned license count, the update process is performed. This process is needed because, in the used license removal process, not all the servers perform the assigned license count update process, and hence the assigned license count stored in the Head server is often different from the true assigned license count at that point of time. Therefore, when newly starting software, in the case where the sum of the assigned license count and the requested license count exceeds the owned license count, the assigned license count update process is performed on all the servers so as to obtain the latest assigned license count in the entire system. When the assigned license count is reduced as the result of this update process, it becomes possible to add licenses up to the number of owned licenses.

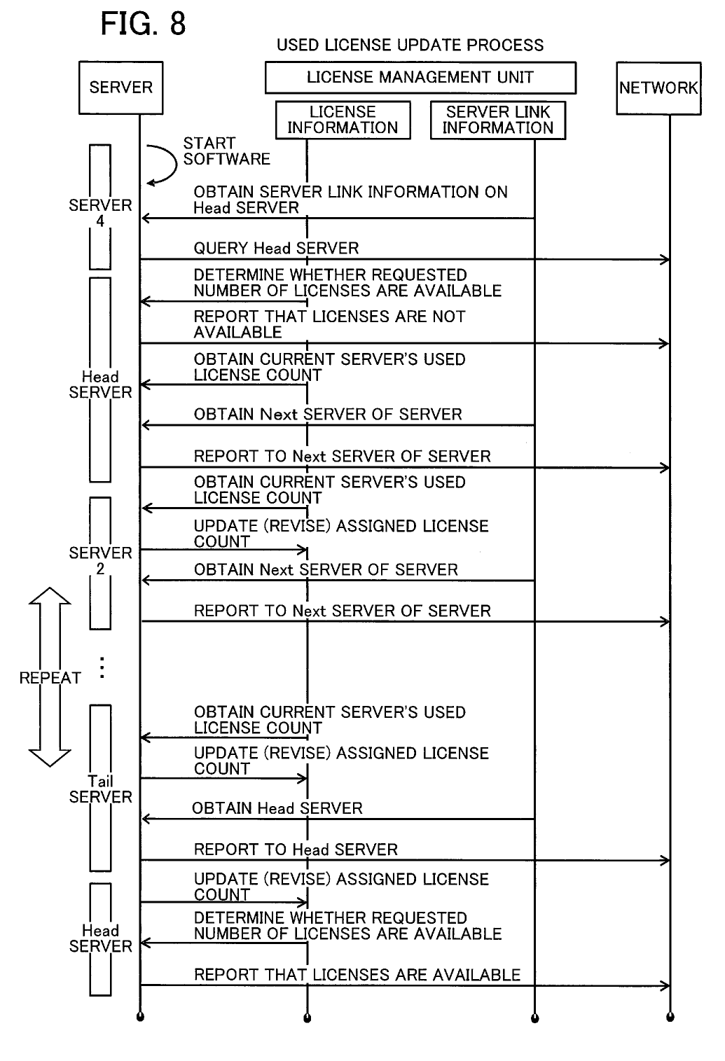

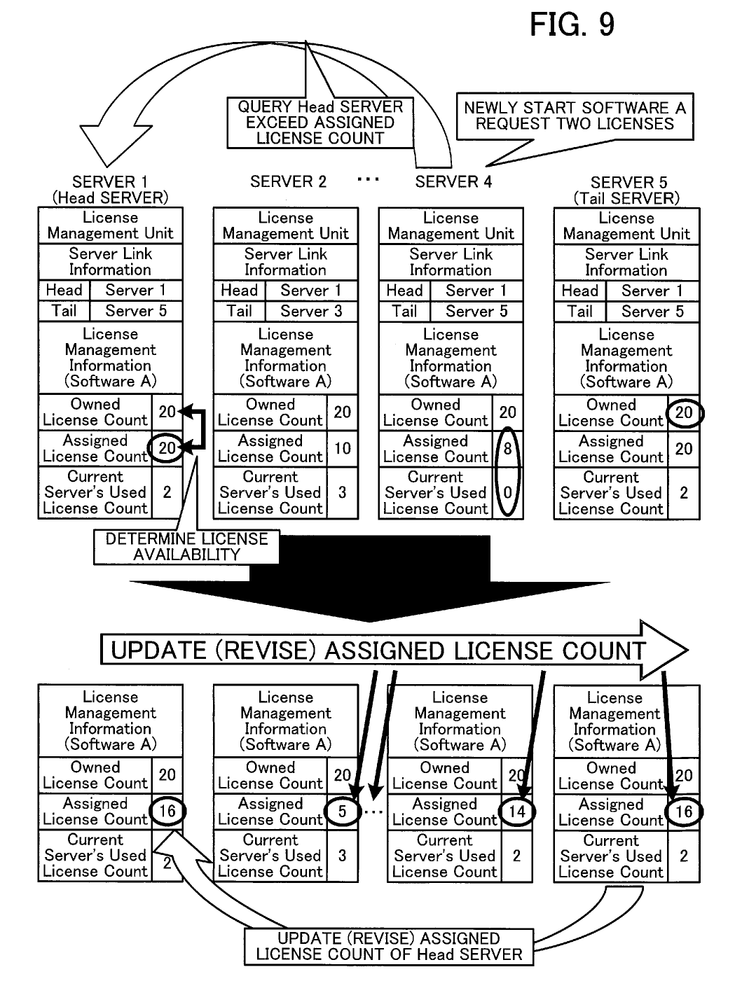

FIG. 8 is a diagram of a processing sequence of license information illustrating the flow of a license update process performed when newly starting software, and FIG. 9 is an explanatory diagram illustrating the flow of a license update process performed when newly starting software.

It is assumed here that in the license management system, both the owned license count and the assigned license count of the software A are “20”. The following describes the case where the server 4 newly starts the software A and requests two licenses.

The license update process starts when the server 4 starts the software A. The server link reference unit 43 of the license management unit 51 of the server 4 obtains the address of the Head server stored in the server link information storage unit 46. Then, the server 4 queries the Head server to determine whether the software A may newly activate two licenses.

In the Head server having received the query from the server 4, the license information reference unit 47 refers to the assigned license count and the Current server's used license count in the license management information storage unit 50. Then, the license information check unit 48 determines whether the requested number of licenses are available. In this example, since the assigned license count has reached the owned license count, the license information check unit 48 determines that no license is available. The determination result indicating that no license is available is reported to the server 4 that has started the software A. Then, in the server 4, the software control unit 41 suspends use of the software A.

Then, in the Head server, the license information reference unit 47 obtains the Current server's used license count in the license management information storage unit 50, and the server link reference unit 43 obtains server link information on the Next server. The obtained Current server's used license count is reported to the obtained Next server, that is, the server 2 in the example of FIG. 8.

In the server 2, the license information reference unit 47 obtains the Current server's used license count in the license management information storage unit 50, and the license information update unit 49 updates (revises) the assigned license count to the sum of the obtained Current server's used license count and the Current server's used license count of the Head server. Then, the server link reference unit 43 obtains server link information on the Next server, and reports the Current server's used license count of the server 2 to the Next server.

Similarly, the server 3 updates (revises) the assigned license count of the server 3 to the sum of the Current server's used license count reported from the server 2 and the Current server's used license count of the server 3, and reports the Current server's used license count of the server 3 to the Next server of the server 3.

This update (revision) of the assigned license count is performed sequentially from the server 2 to the Tail server.

In the Tail server, when the update of the assigned license count is performed, the assigned license count is revised to the total assigned license count of the software A. Then, the Tail server causes the server link reference unit 43 to obtain server link information on the Head server, and reports the updated assigned license count of the Tail server to the Head server. This allows the Head server to obtain the total value of assigned license counts of respective servers.

In the Head server, the license information update unit 49 updates (revises) the assigned license count in the license management information storage unit 50 to the assigned license count reported from the Tail server. Then, the Head server determines whether the number of licenses requested by the server 4 are available. If the Head server determines that the requested number of licenses are available, the Head server reports to the server 4 that licenses are available.

According to the license update process performed when newly starting software, if the sum of the assigned license count in the license information of the Head server and the requested license count exceeds the owned license count, the assigned license count is updated. Thus, in the case where, for example, the result of a license removal process is not reflected to the assigned license count of the Head server, the assigned license count is updated by a revision so as to determine again whether it is possible to assign licenses. Accordingly, the assigned license count does not need to be updated each time a used license removal process is performed. By omitting the process of updating the assigned license count of the Head server upon removal of a used license, it is possible to reduce the amount of processing upon removal of a license.

The following describes a used license removal process performed when shutting down running software. In the following description, it is assumed that in the used license removal process, the assigned license counts of the Head server and the Tail server are updated.

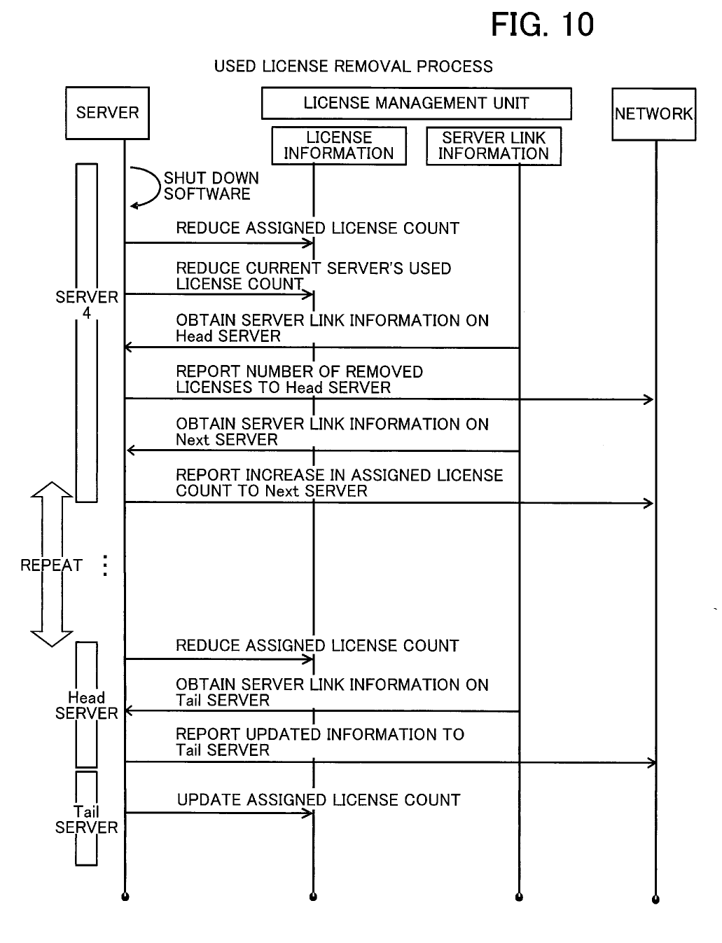

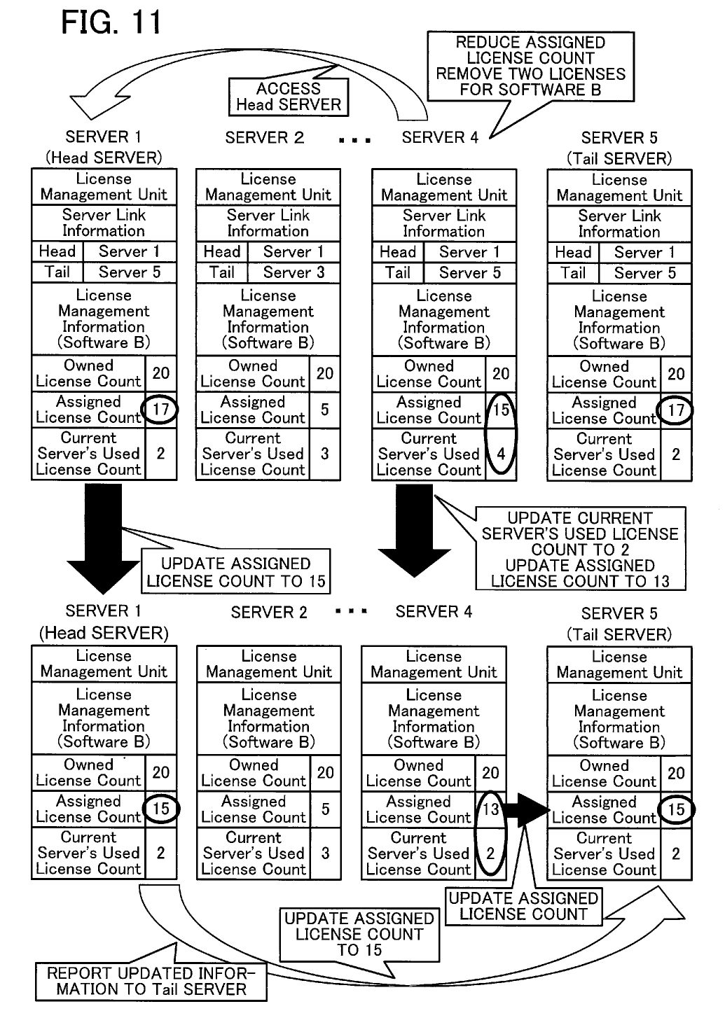

FIG. 10 is a diagram of a processing sequence of license information illustrating the flow of a license removal process performed when shutting down software, and FIG. 11 is an explanatory diagram illustrating the flow of a license removal process performed when shutting down software.

It is assumed here that in the license management system, the owned license count of the software B is “20”, and the assigned license count of the software A is “17”. It is also assumed that in the server 4, the assigned license count in the license information thereof is “15”, and the Current server's used license count is “4”. The following describes the case where two licenses for the software B are removed.

The license removal process starts when the server 4 shuts down the software B. The license information update unit 49 of the license management unit 51 of the server 4 updates the assigned license count and the Current server's used license count in the license management information storage unit 50. In the example of FIG. 11, the assigned license count is reduced from “15” to “13”, and the Current server's used license count is reduced from “4” to “2”.

Then, the server 4 causes the server link reference unit 43 to obtain server link information on the Head server stored in the server link information storage unit 46. Then, the server 4 accesses the Head server to report the number of removed licenses for the software B.

Then, the license management unit 51 of the server 4 causes the server link reference unit 43 to obtain the address of the Next server stored in the server link information storage unit 46, and reports the reduction in the assigned license count to the Next server.

Upon receiving the report indicating that the assigned license count is reduced by “2”, the server identified as the Next server updates the assigned license count in the license management information thereof by reducing its value by “2”. In the assigned license update process, the operation of sequentially updating the assigned license count by reducing its value by “2” is repeated, starting from the server 4 that has shut down the software B and proceeding to the subsequent servers in the startup order.

Then, in the Head server, the license information update unit 49 updates the assigned license count in the license management information storage unit 50. In the example of FIG. 11, since the assigned license count stored in the Head server is “17”, the assigned license count is reduced to “15”.

Then, the Head server causes the server link reference unit 43 to obtain server link information on the Tail server, and reports the updated assigned license count to the Tail server.

Then, in the Tail server having received the updated information from the Head server, the license information update unit 49 updates the assigned license count in the license management information storage unit 50. In the example of FIG. 11, since the assigned license count updated in the Head server is “15”, the assigned license count of the Tail server is also updated to “15”.

With this license removal process performed when shutting down software, since only the server that has shut down the software, the Head server, and the Tail server perform updates. Therefore, it is possible to complete the license removal process in a short time.

The following describes a process performed when changing the configuration of servers.

(Processing of Server Link Information Performed when Newly Adding Server)

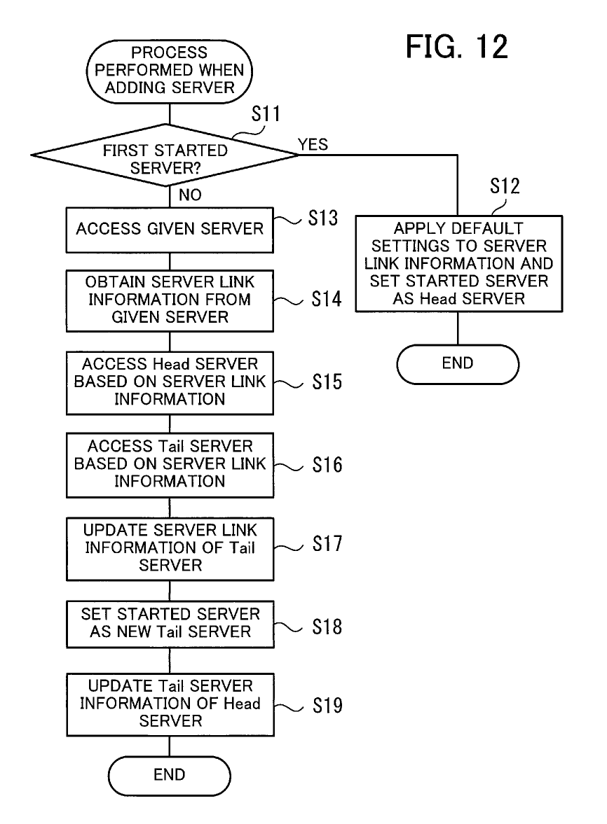

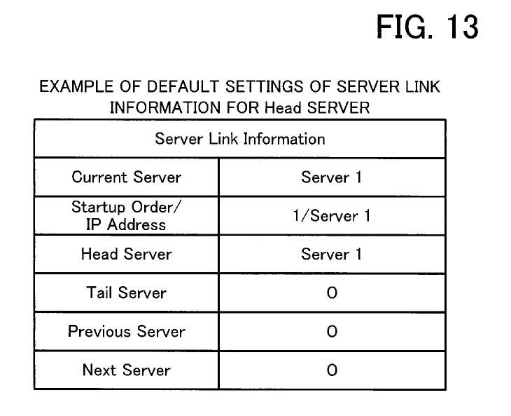

FIG. 12 is a flowchart illustrating the flow of processing of server link information performed when newly adding a server, and FIG. 13 illustrates an example of default settings of server link information for a Head server.

(Step S11) When a server is newly started by, for example, an operator, the started server broadcasts a query, and determines whether the started server is the first started server based on whether a response is returned. If the started server is the first started server, the process proceeds to step S12. If one or more servers have already been started, the process proceeds to step S13.

(Step S12) If the started server is the first started server, the started server applies the default settings to the server link information to set itself as the Head server. For example, the information illustrated in FIG. 13 is applied as the server link information for the Head server. More specifically, the Current server and the Head server are set to the started server (server 1), and the place in the startup order is set to “1”. The Tail server, the Previous server, and the Next server are set to 0 (default value).

(Step S13) The started server accesses a given server that has returned a response to the query.

(Step S14) The given server obtains the address of the Head server from the server link information storage unit 46, and returns the address to the started server.

(Step S15) The started server accesses the Head server based on the server link information obtained from the given server, and obtains the address of the Tail server.

(Step S16) The started server accesses the Tail server to report that the started server becomes the new Tail server.

(Step S17) Upon receiving the report, the Tail server updates each of the Next server and the Tail server in the server link information to the started server.

(Step S18) The started server sets itself as the new Tail server.

(Step S19) The started server reports this to the Head server, so that the Head server updates the Tail server in the server link information to the started server.

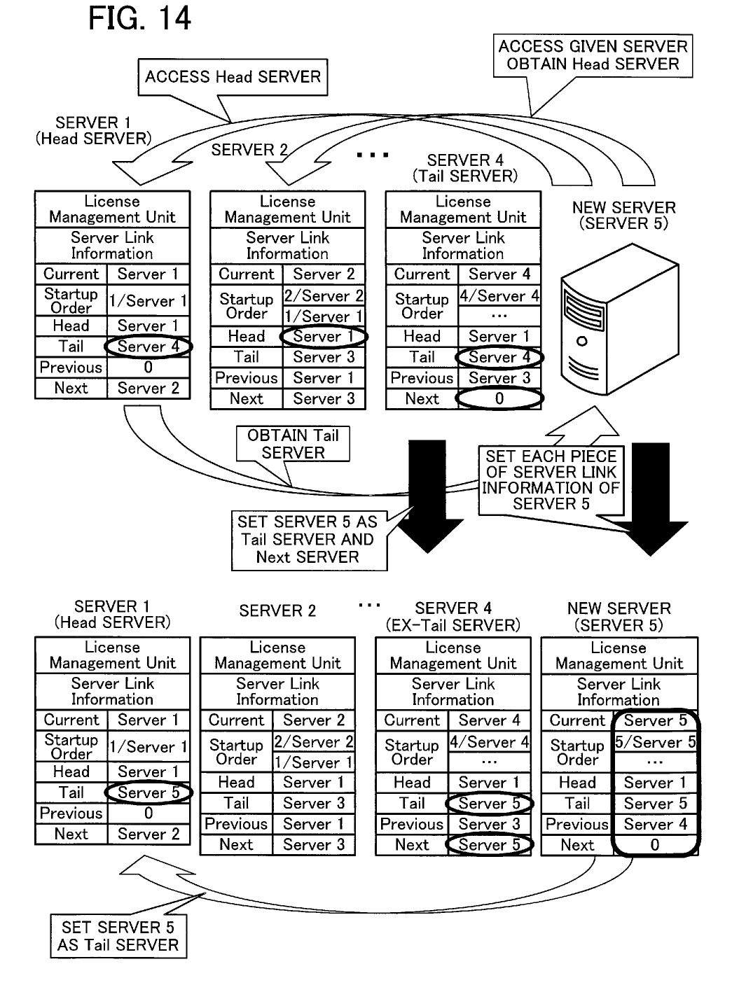

FIG. 14 is an explanatory diagram illustrating the flow of a server link information update process performed when newly adding a server. In the example of FIG. 14, the server 5 is newly started while four servers (servers 1 to 4) are running. In this case, the server 5 accesses a given server (server 2 in this example) to obtain the address of the Head server (server 1). Then, the server 5 accesses the Head server (server 1) to obtain the address of the Tail server (server 4).

Then, the server 5 accesses the Tail server (server 4) to report that the server 5 becomes the Tail server. Then, the Tail server (server 4) updates the server link information. More specifically, the Tail server (server 4) sets each of the Next server and the Tail server in the server link information to the server 5.

Then, the server 5 sets itself as the Tail server. More specifically, the server 5 sets the Tail server in the server link information to the server 5, and sets the Previous server in the server link information to the server 4. Further, the server 5 sets the Current server in the server link information to the server 5, and sets the startup order in the server link information by adding information on the startup order and the server 5 to the server link information obtained from the server 4.

Finally, the Tail server in the server link information of the server 5 is reported to the Head server (server 1). Then, in the Head server (server 1), the Tail server in the server link information is updated to the server 5. Thus, server link information including the newly started server is created in all the running servers.

The above has described the operations performed in the case where the newly started server is the third or later started server. In the case where the newly started server is the second started server, the operations in steps S15 to S17 of FIG. 12 are not needed. More specifically, the started server sets itself as the Tail server. Further, since the Tail server in the server link information of the Head server (server 1) has been set to “0”, the Head server sets the address of the started server to the Tail server and the Next server in the server link information.

The following describes processing of server link information performed when shutting down a running server.

(Processing of Server Link Information Performed when Shutting Down Running Server)

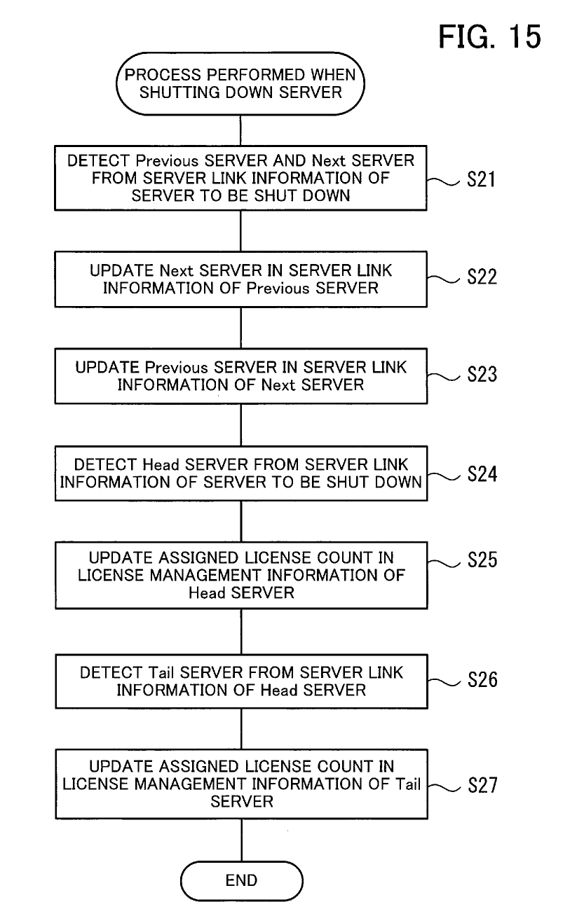

FIG. 15 is a flowchart illustrating the flow of processing of server link information performed when shutting down a running server.

(Step S21) A server to be shut down detects the addresses of the Previous server and the Next server from the server link information thereof, and notifies the Previous server and the Next server that the server is to be shut down.

(Step S22) The Previous server updates the Next server in the server link information thereof to the Next server of the server to be shut down.

(Step S23) The Next server updates the Previous server in the server link information thereof to the Previous server of the server to be shut down.

(Step S24) The server to be shut down detects the address of the Head server from the server link information thereof, and accesses the Head server to report the Current server's used license count.

(Step S25) The Head server updates the assigned license count in the license management information thereof by subtracting the Current server's used license count of the server to be shut down.

(Step S26) The Head server detects the address of the Tail server from the server link information thereof, and accesses the Tail server to report the updated assigned license count.

(Step S27) The Tail server updates the assigned license count in the license management information thereof to the reported assigned license count.

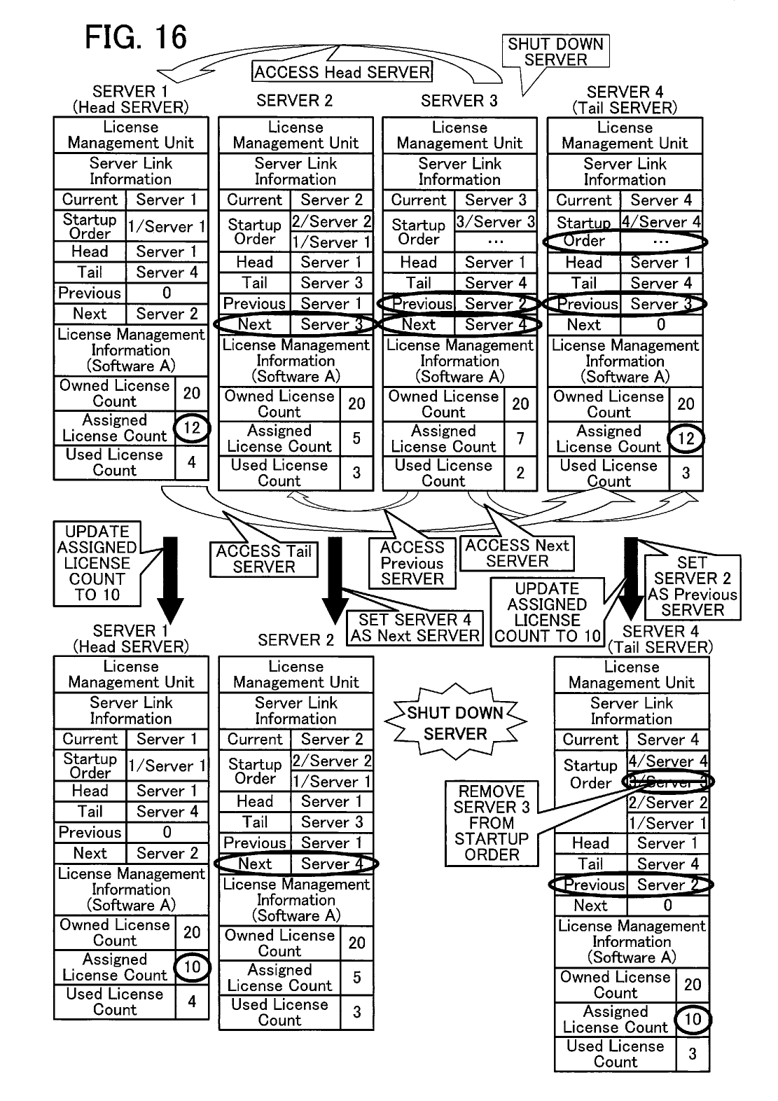

FIG. 16 is an explanatory diagram illustrating the flow of a server link information update process performed when shutting down a running server. In the example of FIG. 16, the server 3 among four running servers (servers 1 to 4) is shut down. In this case, the server 3 changes the server link information and the license management information of each of the preceding server and the following server (Previous server and Next server) of the server 3 in the startup order, and the license management information of the Head server.

In order to do so, first, the server 3 to be shut down detects the addresses of the Previous server and the Next server from the server link information thereof. Then, the server 3 accesses the Previous server (server 2) to report that the Next server of the server 2 is changed to the Next server (server 4) of the server 3. Upon receiving the report, the server 2 updates the Next server in the server link information thereof to the server 4.

Then, the server 3 accesses the Next server (server 4) to report that the server 3 is shut down. Upon receiving the report, the server 4 updates the Previous server in the server link information thereof to the server 2, and deletes the information on the server 3 from the information on the startup order in the server link information.

Then, the server 3 detects the address of the Head server from the server link information thereof, and accesses the Head server to report the Current server's used license count of the software A in the license management information of the server 3 that is to be shut down. Upon receiving this report, the Head server updates the assigned license count of the software A in the license management information. In the example of FIG. 16, since the assigned license count of the Head server is “12” and the Current server's used license count of the server 3 to be shut down is “2”, the assigned license count of the Head server is updated to “10”.

Then, the Head server detects the address of the Tail server from the server link information thereof, and accesses the Tail server to report the updated assigned license count “10” of the Head server. Upon receiving the report, the Tail server (server 4) updates the assigned license count of the server 4 to “10”.

In this manner, the server link information and the license management information of all the servers excluding the server 3 to be shut down are reconfigured, so that there is no server that has the server link information on the server 3. Thus, the server 3 is ready to be shut down.

The following describes the procedure of restoring server link information and license management information of a normally running server in the case where a failed server is found. The restoration of server link information and license management information utilizes the configuration in which servers are linked in the startup order and pieces of information are accumulated in the startup order. That is, pieces of server link information are linked together by specifying each of the first started Head server to the last started Tail server as a Previous server and a Next server. Further, pieces of information on started servers are accumulated and stored in the order in which the servers are started. These pieces of management information are stored in both the Head server and the Tail server. Accordingly, if any of the servers in the server link fails, these pieces of information are restored based on the pieces of server link information that are linked together and stored and the license management information.

Note that the process of restoring server link information and license management information is performed when, for example, the requested number of licenses exceeds the owned license count. Further, a failed server is often detected when the server does not respond to an access from another server in the server link.

<Process Performed when Sever Other than Head Server and Tail Server has Failed>

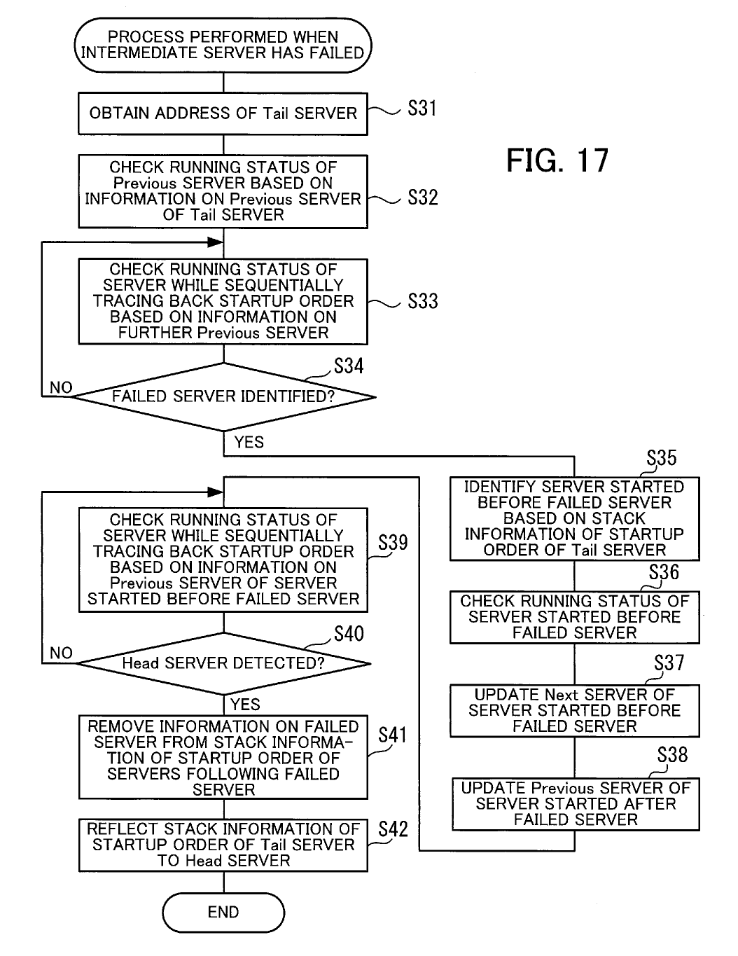

FIG. 17 is a flowchart illustrating the flow of a server link restoration process performed when an intermediate server other than a Head server and a Tail server has failed. The server link restoration process starts in the case where, for example, a server having accessed another server in which a failure has occurred (hereinafter referred to as a failed server) is unable to confirm the running of the other server.

(Step S31) The server having detected a failed server obtains the address of the Tail server from the server link information thereof, and accesses the Tail server to request restoration of the server link.

(Step S32) The Tail server obtains the address of the Previous server from the server link information thereof, and accesses the Previous server to check the running status of the Previous server.

(Step S33) The immediately previous server of the Tail server in the startup order obtains the address of the Previous server from the server link information thereof, and accesses the Previous server to check the running status of the Previous server.

(Step S34) The server that has accessed the Previous server determines whether the failed server is identified. If the running of the Previous server is confirmed, the process returns to step S33. Thus, the operation of accessing the Previous server and checking the running status of the Previous server is performed sequentially, tracing back the startup order. This operation is repeated until the failed server is identified. If the failed server is identified, the server having identified the failed server reports this to the Tail server. Then, the process proceeds to step S35.

(Step S35) The Tail server identifies a server that was started immediately before the failed server based on stack information of the startup order thereof.

(Step S36) The Tail server accesses the server that was started immediately before the failed server, checks the running status of that server, and reports that the next server in the startup order is the failed server.

(Step S37) The server that was started immediately before the failed server updates the Next server in the server link information thereof to the server that was started immediately after the failed server, and reports this to the server that was started immediately after the failed server.

(Step S38) The server that was started immediately after the failed server (the server that has identified the failed server) updates the Previous server in the server link information thereof to the server that was started immediately before the failed server.

(Step S39) The server that was started immediately before the failed server obtains the address of the Previous server from the server link information thereof, and accesses the Previous server to check the running status of the Previous server.

(Step S40) The server confirmed to be running obtains the address of the Previous server from the server link information thereof, and determines whether the Head server is detected based on whether the obtained address is the default value “0”. If the Head server is not detected, the process returns to step S39. The operations in steps S39 and S40 of checking the running status of a server while further tracing back the server link are repeated until the Head server is detected.

(Step S41) The server having detected the failed server removes information on the failed server from the stack information of the startup order in the server link information of the servers started after the failed server. The removal of information on the failed server is sequentially repeated until the Tail server removes information on the failed server from the stack information of the startup order thereof.

(Step S42) The Tail server transmits the stack information of the startup order to the Head server. The Head server reflects the stack information of the startup order of the Tail server to the stack information of the startup order of the Head server.

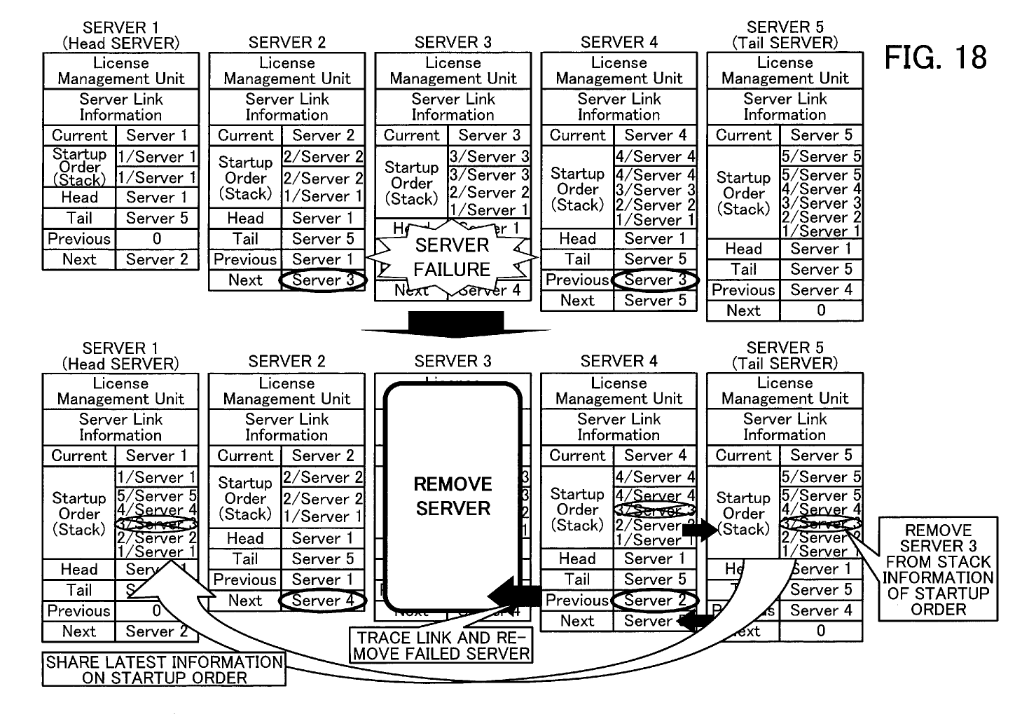

FIG. 18 is an explanatory diagram illustrating the flow of a server link restoration process performed when an intermediate server other than a Head server and a Tail server has failed. In the example of FIG. 18, the server 3 among five running servers (servers 1 to 5) has failed. Further, the failure of the server 3 is detected when, for example, the server 2 accesses the server 3 and is unable to confirm the running of the server 3. In this case, the server 2 obtains the address of the Tail server from the server link information thereof, and reports the presence of a failed server to the Tail server.

Then, the Tail server (server 5) obtains the address of the Previous server (server 4) from the server link information thereof, and accesses the Previous server (server 4) to check the running status of the Previous server (server 4).

Then, similarly, the server 4 obtains the address of the Previous server (server 3) from the server link information thereof, and accesses the Previous server (server 3) to check the running status of the Previous server (server 3).

In this case, the server 4 is unable to confirm the running of the server 3. Thus, the server 4 obtains the address of the Tail server from the server link information thereof, and reports the failure of the server 3 to the Tail server.

Then, the Tail server determines that the Previous server of the failed server 3 is the server 2 based on the stack information of the startup order. Thus, the Tail server accesses the server 2 to check the running status of the server 2, and reports that the Next server is the server 4.

The server 2 updates the Next server in the server link information to the server 4, and reports this to the server 4. Upon receiving the report, the server 4 updates the Previous server to the server 2.

Then, the server 2 accesses the Previous server (server 1) thereof. In the server 1, the Previous server is set to the default value “0”. Thus, the operation of restoring the server link information tracing from the Tail server to the Head server is completed.

However, the information on the server 3 remains in the stack information of the startup order in each of the subsequent servers of the failed server (server 3). Accordingly, first, the server 4 removes the information on the server 3 from the stack information of the startup order thereof, and the server 5 (Tail server) removes the information on the server 3 from the stack information of the startup order thereof.

Finally, the Tail server reports the stack information thereof to the Head server. Then, the Head server updates the stack information of the startup order thereof to the stack information of the startup order of the Tail server, so that the Head server and the Tail server share the latest information on the startup order.

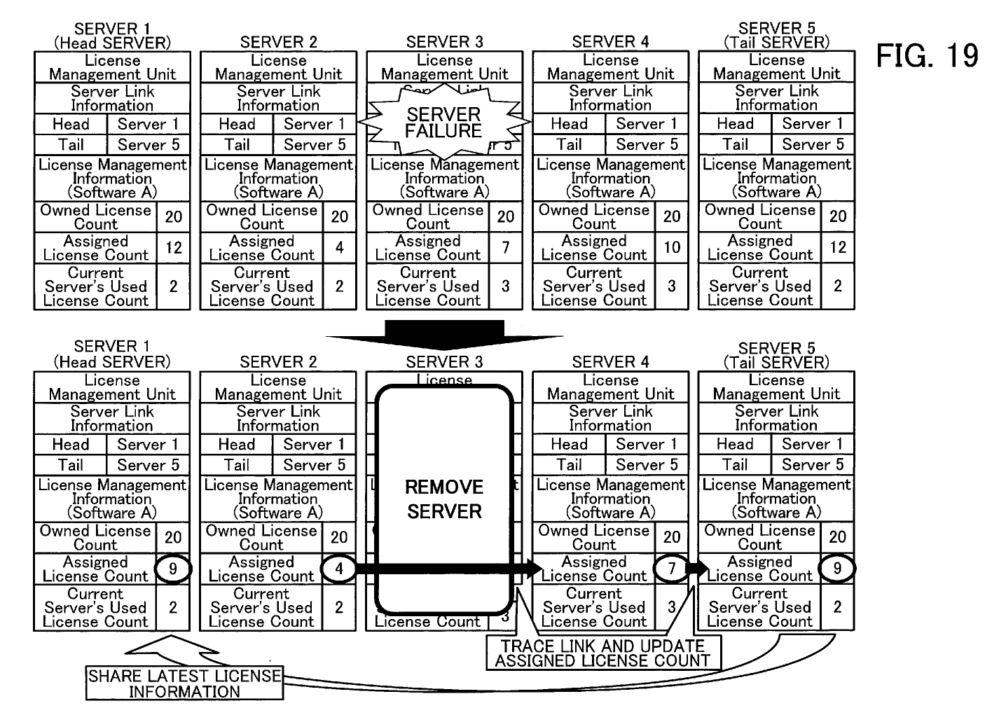

FIG. 19 is an explanatory diagram illustrating the flow of a license information restoration process performed when an intermediate server other than a Head server and a Tail server has failed. The restoration of license information is performed together with the restoration of server link information described above.

That is, if the server 3 fails, restoration of license information is performed that reduces, based on the assigned license count of the server 2, the assigned license count of each of the servers started after the server 3 by the number of licenses used by the server 3 (the Current server's used license count), tracing the link.

It is assumed here that the assigned license count of the server 2 is “4”; the used license count of the server 3 is “3”; the used license count of the server 4 is “3”; and the used license count of the server 5 is “2”. The server 2 having updated the Next server to the server 4 in response to the failure of the server 3 transmits the assigned license count “4” of the server 2 to the server 4. The server 4 updates the assigned license count of the server 4 to the sum “7” of the assigned license count “4” of the server 2 and the used license count “3” of the server 4. Then, the server 4 transmits the updated assigned license count “7” of the server 4 to the server 5. The server 5 updates the assigned license count of the server 5 to the sum “9” of the assigned license count “7” of the server 4 and the used license count “2” of the server 5. Then, the server 5 transmits the updated assigned license count “9” of the server 5 to the server 1 as the Head server. The server 1 sets the assigned license count “9” of the server 5 as the assigned license count of the server 1. Thus, the Head server and the Tail server share the latest license information.

The following describes a process performed when a Tail server has failed.

<Process Performed when Tail Server has Failed>

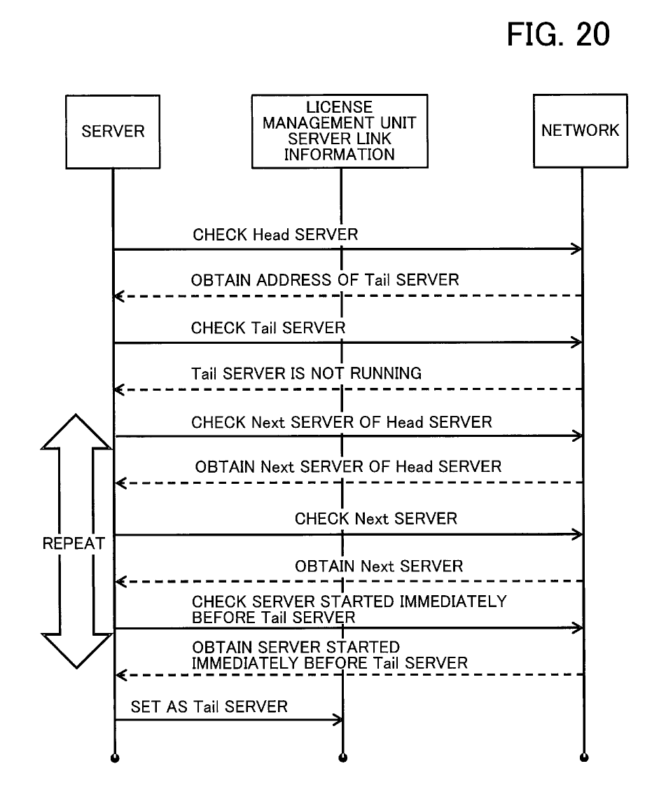

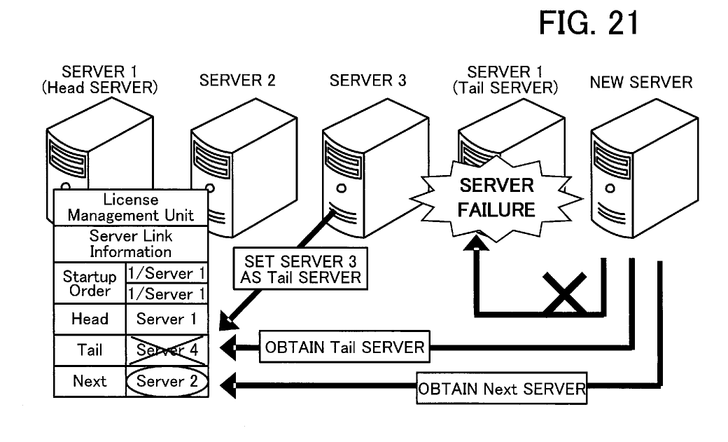

FIG. 20 is a processing sequence diagram illustrating the flow of a process performed when a Tail server has failed, and FIG. 21 is an explanatory diagram illustrating the flow of a process performed when a Tail server has failed.

If the Tail server has failed, the running status of the Next server is checked sequentially in the startup order, starting from the Head server, and the server that was started immediately before the Tail server is set as the Tail server.

That is, as illustrated in FIG. 20, first, the server having detected a failed server checks the Head server, and obtains the address of the Tail server from the Head server. Then, the server detected the failed server accesses the Tail server, and determines that the Tail server is not running.

Then, the server checks the Next server of the Head server, and obtains the address of the Next server from the Head server. Then, the operation of checking the running status of the Next server and obtains the address of the Next server from that server is repeated, thereby checking the running status of a server sequentially in the startup order, starting from the Head server.

Finally, the server that was started immediately before the Tail server is set as the Tail server.

In this manner, in the case where the Tail server has failed, since the license information of the server that was started immediately before the Tail server includes the whole license information at the time before the startup of the Tail server, it is not needed to restore the license information.

FIG. 21 illustrates a specific example of a process performed when a Tail server has failed. In this example, the server 4 is the Tail server, and the Tail server has failed. The failure of the Tail server is detected when the Tail server is checked upon newly adding a server.

First, the new server queries a given server to obtain the address of the Head server, and accesses the Head server. The new server accesses the Tail server (server 4) obtained from the Head server, but is unable to confirm the running of the Tail server (server 4).

Then, the running status of the server 2 is checked by the Head server; the running status of the server 3 is checked by the server 2; and so on, in the order of startup. Thus, it is determined that the server 4 is the failed server, and the server 3 is the server at the end of the link.

Then, the new server accesses the server 3. The server 3 updates the Next server thereof to “0” and sets the server 3 as the Tail server in the server 3, thereby restoring the server link. Finally, the server 1 updates the Tail server in the server link information to the server 3.

The following describes a process performed when a Head server has failed.

<Process Performed when Head Server has Failed>

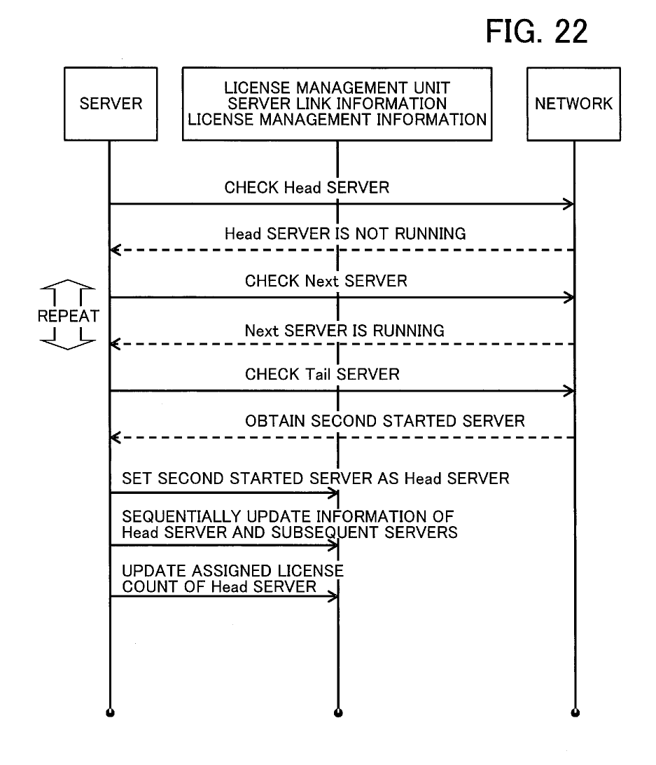

FIG. 22 is a processing sequence diagram illustrating the flow of a process performed when a Head server has failed. The failure of the Head server is detected when another server is not able to access the Head server.

In this case, the server having detected the failure of the Head server obtains the address of the Head server from a given server, accesses the Head server, and determines that the Head server is not running. The server having detected the failure of the Head server obtains the address of the Next server from a given server, and checks the running status of the server that was started immediately after the given server. The operation of checking the running status of the Next server is repeated until the running status of the Tail server as the Next server is determined.

When the running status of the Tail server is checked, the Tail server obtains the second started server (server 2) from the stack information of the startup order in the server link information thereof, and reports the failure of the Head server to the server 2.

Upon receiving the report indicating the failure of the Head server, the server 2 sets itself as the Head server. Then, information of the new Head server and the subsequent servers, that is, the startup order, the Head server, and the Previous server in the server link information, and the assigned license count in the license management information are updated sequentially in the startup order.

Then, when the update of the information of the Tail server is completed, the Tail server reports the assigned license count in the license management information thereof to the new Head server. The new Head server updates the assigned license count in the license management information thereof to the reported assigned license count of the Tail server.

The following describes a process performed when both a Head server and a Tail server have failed.

<Process Performed when Both Head Sever and Tail Server have Failed>

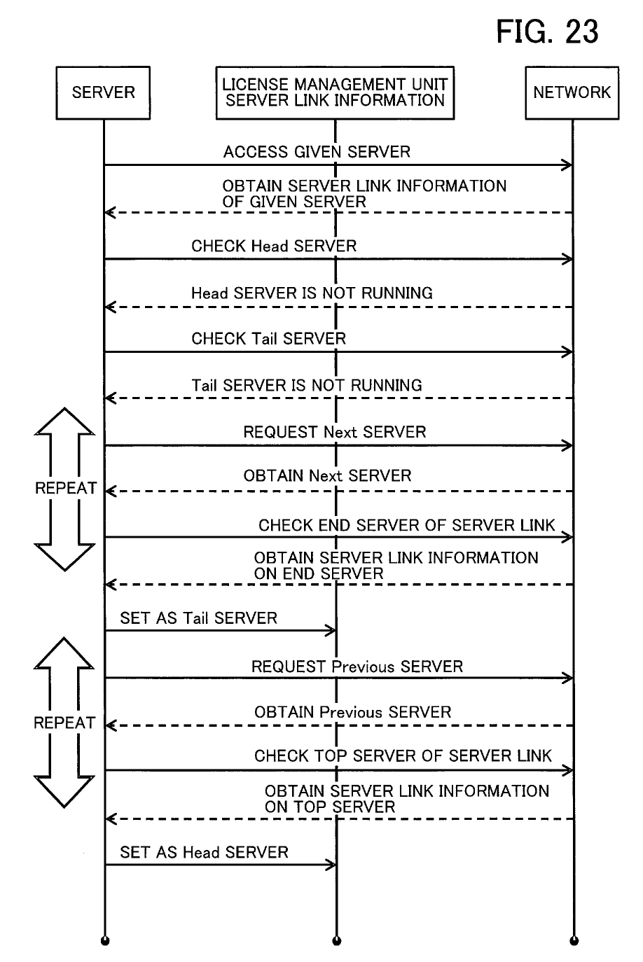

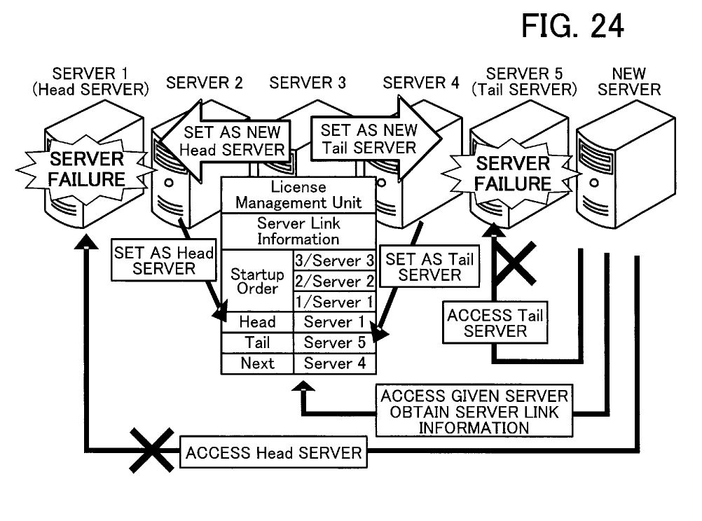

FIG. 23 is a processing sequence diagram illustrating the flow of a process performed when both a Head server and a Tail server have failed, and FIG. 24 is an explanatory diagram illustrating the flow of a process performed when both a Head server and a Tail server have failed.

A server accesses a given server, obtains server link information from the given server, and accesses the Head server based on the obtained server link information. Then, if the server finds that the Head server is not running, the Head server is determined to have failed. Further, when the server accesses the Tail server based on the obtained server link information and finds that the Tail server is not running, the Tail server is determined to have failed.

In the case where both the Head server and the Tail server have failed as described above, the running status of a server is checked sequentially in the startup order, starting from the server that has provided the server link information, based on the Next server in the server link information of that server. When the operation of checking the running status of a server accessed based on the Next server is completed, a server at the end of the server link information is detected. The server at the end is set as the Tail server.

Then, the running status of a server is checked sequentially based on the Previous server in the server link information, starting from the server that has provided the server link information and tracing back the startup order. The last server confirmed to be running is set as the Head server. Then, update of the information on the Next server and the Head server to the new Next server and the new Head server is performed sequentially in the order from the new Head server to the new Tail server.

In this way, server link information on the new Head server to the new Tail server is restored. Each of the new Head server and the new Tail server performs the assigned license count update (revision) process of FIG. 9 so as to obtain the total value of the assigned license counts of the respective servers and sets the total value as the assigned license count in each of the new Head server and the new Tail server.

FIG. 24 illustrates a specific example of a process performed when both a Head server and a Tail server have failed. In this example, the server 5 is the Tail server; the Tail server has failed; and the Head server has also failed. The failures of the Tail server and the Head server are detected when the Tail server and the Head server are checked upon newly adding a server.

First, the new server accesses a given server (server 3 in this example) to obtain the address of the Head server, and accesses the Head server. However, the new server is unable to confirm the running of the Head server. Then, the new server accesses the Tail server based on the address of the Tail server obtained from the server 3. However, the new server is again unable to confirm the running of the Tail server.

In this case, the new server checks the running status of the server 4 that was started immediately after the queried server 3, and the server 4 checks the running status of the server 5 that was started immediately after the server 4. The server 4 is unable to confirm the running of the server 5, so that the server 4 is set as the Tail server.

The new server also checks the running status of the server 2 that was started immediately before the queried server 3, and the server 2 checks the running status of the server 1 that was started immediately before the server 2. The server 2 is unable to confirm the running of the server 1, so that the server 2 is set as the Head server.

In the above example, in the case where both the Head server and the Tail server have failed, a server that was started immediately after the Head server and a server that was started immediately before the Tail server are detected by tracing the server link. However, for example, management information in a dynamic host configuration protocol (DHCP) server may be used for detecting a server that was started immediately after the Head server and a server that was started immediately before the Tail server. For example, the address of each of the new Head server and the new Tail server may be obtained based on the release date of the IP address managed by the DHCP server and the value of the IP address managed by the user.

The following describes an example of settings of server link information in a cloud environment.

<Example of Settings of Server Link Information in Cloud Environment>

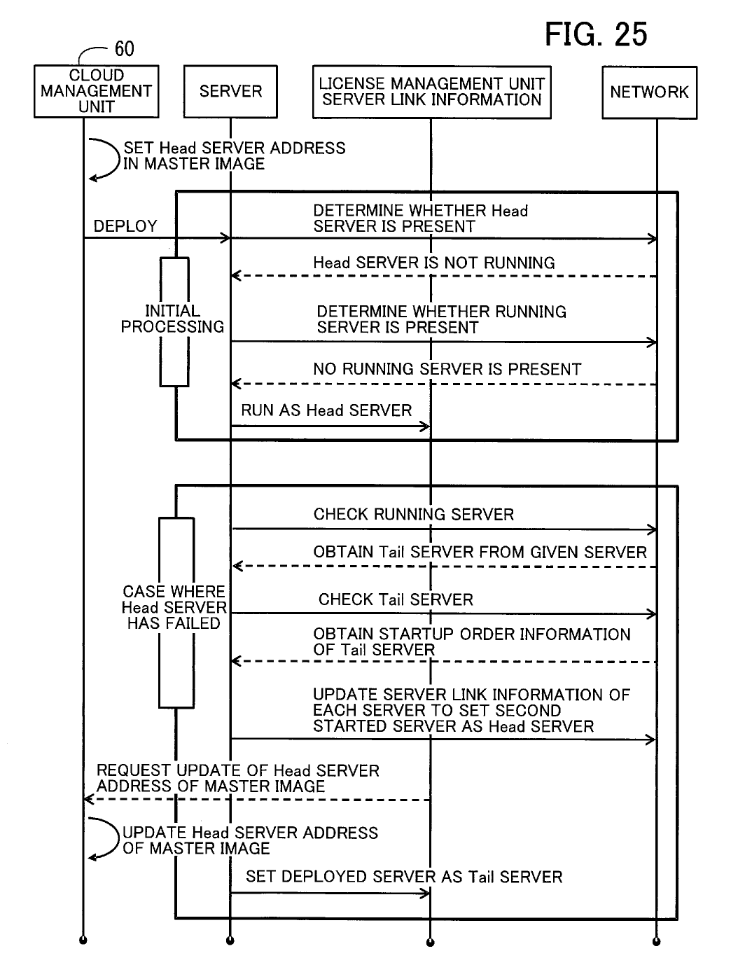

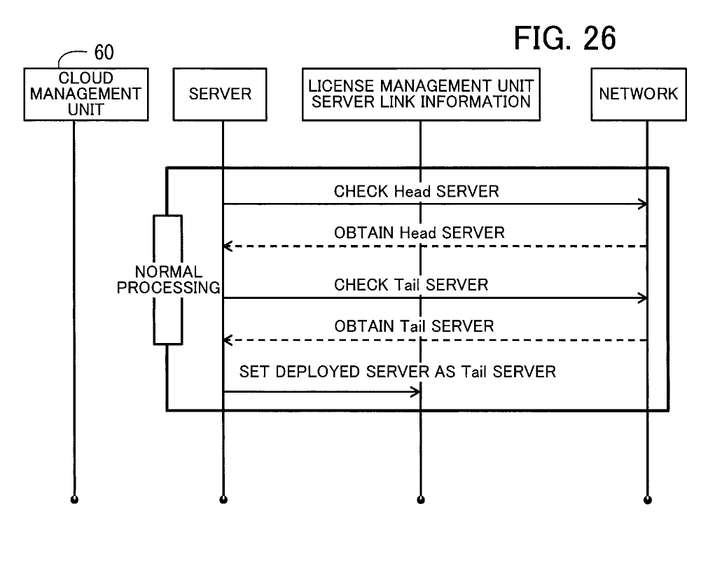

FIGS. 25 and 26 are processing sequence diagrams illustrating the flow of updating server link information in a cloud environment.

First, a description will be given of initial processing performed when newly deploying a server in a cloud environment. In this case, a cloud management unit 60 creates a master image with a constructed system, and deploys the master image in a cloud environment to construct a system. In this environment, a system (master image) that serves as a master in a system configuration designed in advance is created. When designing the master image, the address of the Head server is determined in advance, and this address is set for the Head server in the server link information of the master image.

First, the master image deployed in the cloud environment is started, determines whether a Head server is present, and determines that no Head server is running. Then, the master image determines whether a running server is present, and determines that no running server is present. In the case where neither a Head server nor a running server is present as described above, the master image is the first deployed server. Further, since the master image has already been set as the Head server, the master image is able to run as the Head server without making any change.

In the case where one or more servers have been running when the master image is deployed in the cloud environment and the Head server has failed, the master image first identifies the running servers. Then, the master image obtains the address of the Tail server from a given server. Then, the master image accesses the Tail server, and obtains the information on the startup order of the Tail server. Then, based on the information on the startup order of the Tail server, the master image sets the second started server as the Head server, and then updates the server link information of each server. Thus, the server link information of each of the servers excluding the master image is restored.

Then, the master image requests the cloud management unit 60 to update the Head server address of the master image. The cloud management unit 60 updates the Head server address of the master image to the address of the second started server, and prepares for a process of newly adding a server.

Then, the master image deployed in the cloud environment is set as the Tail server, and a Tail server in the server link information of the Head server is updated.

In normal processing that deploys a master image in a cloud environment in which a plurality of servers have already been running, the master image checks the running status of the Head server and the Tail server, and sets itself as the Tail server.

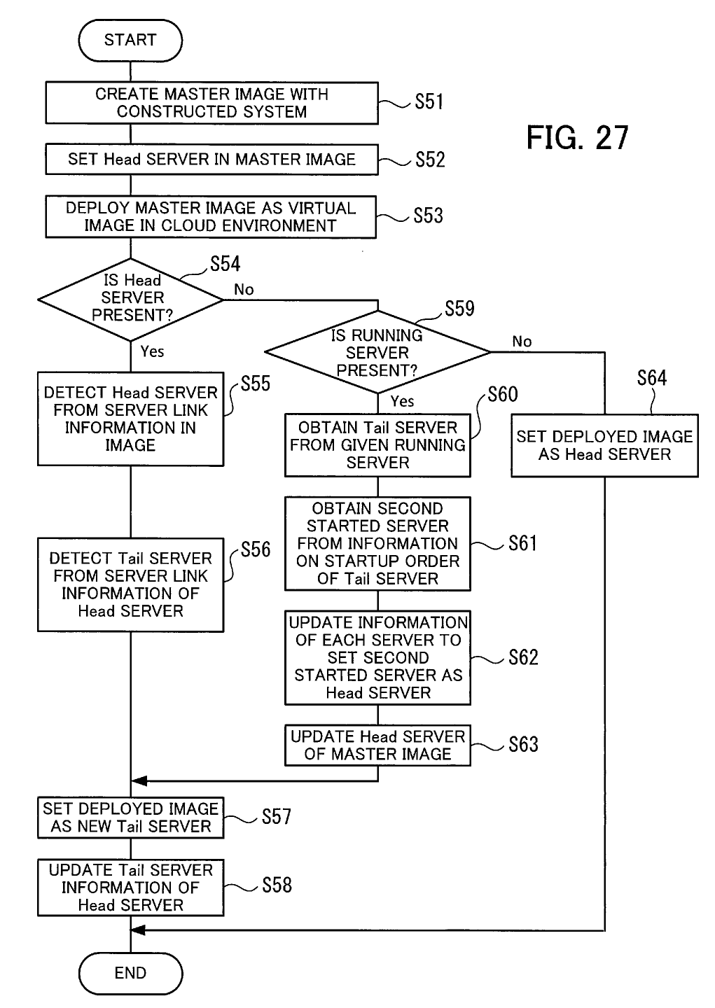

FIG. 27 is a flowchart illustrating the flow of updating server link information in a cloud environment.

(Step S51) In the cloud management unit 60, a master image with a constructed system is created.

(Step S52) The cloud management unit 60 sets information for being a Head server in the master image.

(Step S53) The cloud management unit 60 deploys the master image as a virtual image in the cloud environment.

(Step S54) The master image deployed in the cloud environment is started, and determines whether a Head server is present in the cloud environment where the master image is deployed. If a Head server is present, the process proceeds to step S55. If a Head server is not present, the process proceeds to step S59.

(Step S55) The master image detects a Head server from the server link information that is set in the image.

(Step S56) The master image accesses the Head server, and detects a Tail server from the server link information of the Head server.

(Step S57) The master image accesses the Tail server so as to update information indicating the Tail server and the Next server in the server link information, and sets the deployed master image as the new Tail server.

(Step S58) The master image accesses the Head server, and updates information on the Tail server in the Head server to information on the new Tail server.

(Step S59) The master image determines whether another running server is present. If a running server is present although a Head server is not present, the process proceeds to step S60. If neither a running server nor a Head server is present, the process proceeds to step S64.

(Step S60) The master image detects the address of the Tail server from a given running server.

(Step S61) The master image accesses the Tail server, obtains the address of the second started server from the information on the startup order of the Tail server, and accesses the second started server.

(Step S62) The second started server updates the server link information to set the second started server as the Head server. The third started server and the subsequent servers also sequentially update the Head server in the server link information of the respective servers including the master image.

(Step S63) The master image updates the address of the Head server of the master image to the address of the new Head server.

(Step S64) If neither a Head server nor another running server is present, the master image sets the deployed master image as the Head server.

The following describes an example of deployment of a master image in a cloud environment.

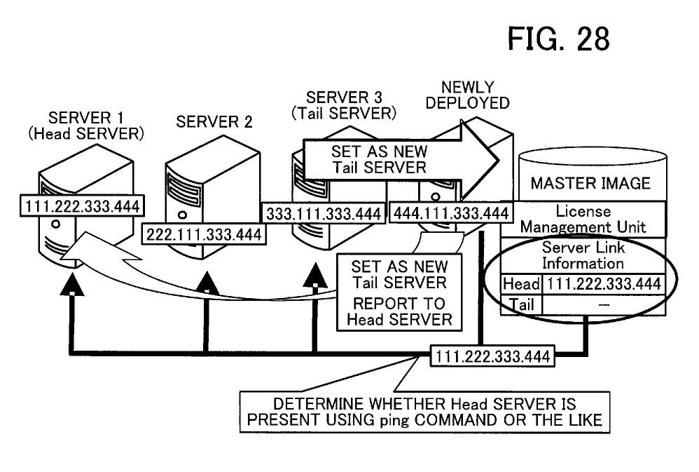

FIG. 28 is an explanatory diagram illustrating an example of image deployment in a cloud environment in the case where a Head server is present. In the case of deploying a master image that is set to be a Head server as a new server in a cloud environment in which a Head server is present, the master image first determines whether a Head server is present. For example, the master image specifies the address of the Head server stored therein and executes a ping command, and determines whether a Head server is present based on whether a response is returned. If a response is returned, a Head server is already present.

In this case, the master image changes the Tail server from the server 3 to the master image. Then, the master image reports to the Head server that the master image has become the new Tail server so as to update the information on the Tail server in the Head server.

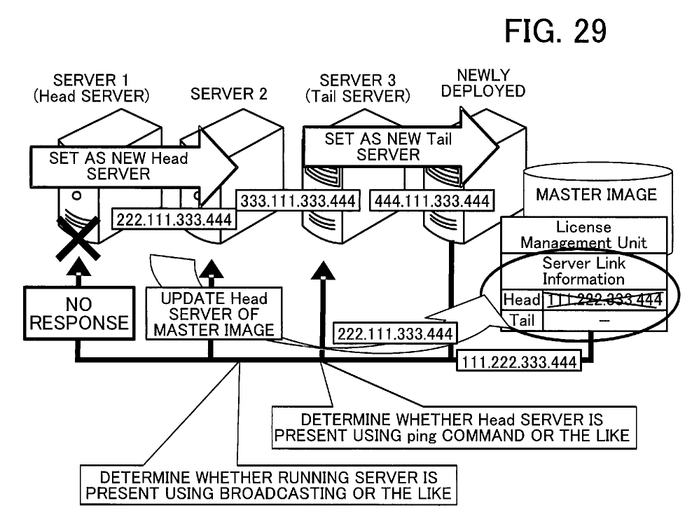

FIG. 29 is an explanatory diagram illustrating an example of image deployment in a cloud environment in the case where a Head server has failed and a running server is present. In the case of deploying a master image that is set to be a Head server as a new server in a cloud environment in which a Head server has failed and a running server is present, the master image first determines whether a Head server is present.

In this case, no response is returned from the Head server. Then, the master image determines whether a running server is present. For example, the master image broadcasts a query without specifying the destination, and determines whether a running server is present based on whether a response to the query is returned. If a response is returned, a running server other than the Head server is present.

If a Head server is not present but a running server is present, the master image obtains the address of the Tail server from a given server that has returned a response, and obtains the address of the second started server from the server link information of the Tail server. Then, the master image transmits to the second started server 2 a request for setting the second server as the Head server and transmits to the server 3 a request for updating server link information on the Head server. Then, the master image updates the link information on the Head server to the link information on the server 2, sets the master image as the new Tail server, and transmits the link information on the Tail server to the Head server.

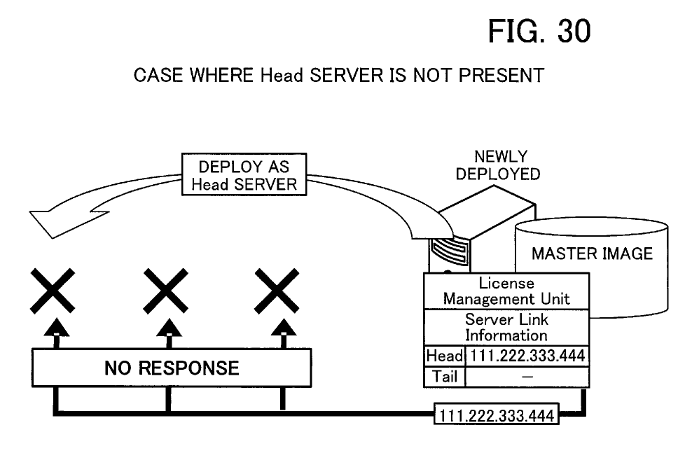

FIG. 30 is an explanatory diagram illustrating an example of image deployment in a cloud environment in the case where a Head server is not present. In the case where neither a Head server nor a running server is present, even when the master image executes a ping command specifying the address of the Head server or performs a broadcast without specifying the destination, no reply is returned. In this case, the master image determines that no server is present in a cloud environment where the master image is deployed, and thus is deployed as the Head server.

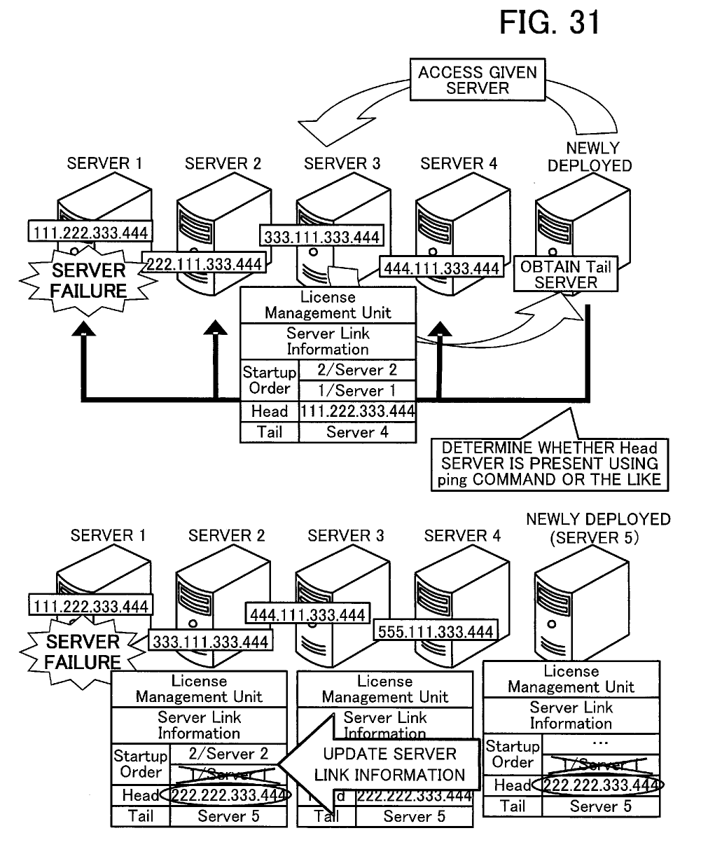

FIG. 31 is an explanatory diagram illustrating an example where, during image deployment in a cloud environment in which a Head server and a running server are present, the Head server has failed. In the case where, when the master image is additionally deployed in a continuous manner in a cloud environment in which a Head server and a running server are present, the Head server (server 1) fails, it is not possible to obtain server link information on the Tail server from the server 1. Therefore, the master image obtains server link information on the Tail server from a given server, and removes server link information on the Head server from the obtained information on the startup order. Further, the master image updates its server link information on the Head server to server link information on the second started server 2, and updates its server link information on the Tail server to the server 5.

Then, the operation performed in the server 5 for removing the server link information on the Head server from the information on the startup order, updating the server link information on the Head server to the server 2, and updating the server link information on the Tail server to the server 5 is also performed in other running servers. That is, the operation performed in the server 5 is repeated, starting from the server 4 deployed before the server 5 and tracing back the startup order to the server 2.

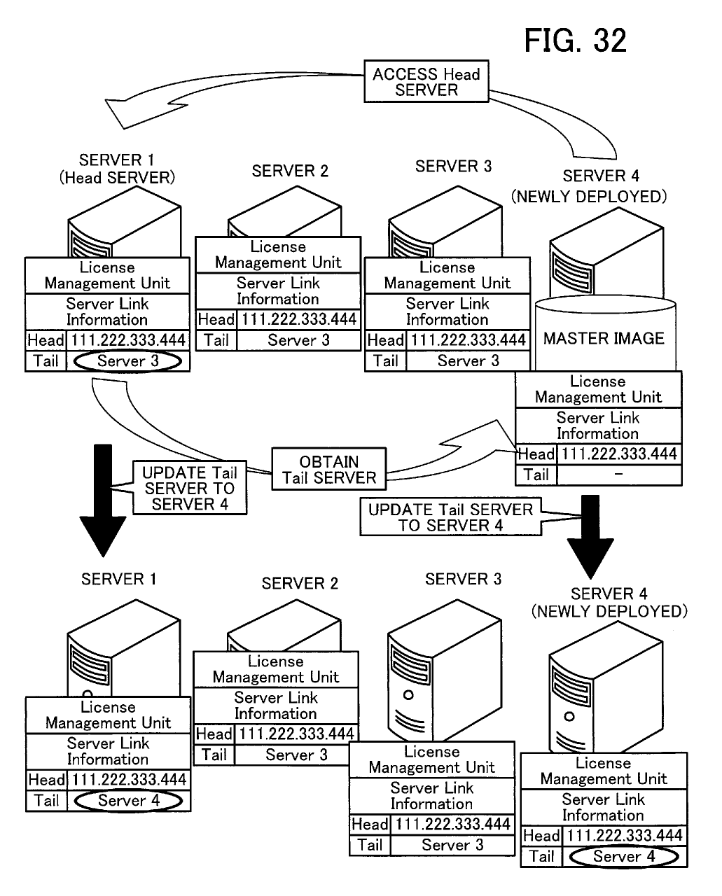

FIG. 32 is an explanatory diagram illustrating an example of image deployment in a cloud environment in the case where a Head server and a running server are present. In the case of additionally deploying a master image in a continuous manner in a cloud environment where a Head server and a running server are present, the newly deployed master image performs an operation for setting itself as a Tail server.

More specifically, the master image accesses the Head server based on the server link information thereof to obtain server link information on the Tail server, and updates server link information on the Tail server to the server 4 based on the obtained information. The Head server also updates server link information on the Tail server to the server 4.

According to one aspect, it is possible to quickly perform a license check when newly starting software.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An information processing system comprising:
a plurality of information processing apparatuses, each of the plurality of information processing apparatuses including
a memory configured to store an assigned license count indicating a number of licenses that have already been assigned, and
a processor;
wherein the processor of one of the plurality of information processing apparatuses excluding a first started information processing apparatus in a startup order of the plurality of information processing apparatuses, the startup order being stored in the memory, is configured to: upon additionally assigning one or more licenses to the one of the information processing apparatuses, add an additional license count to an assigned license count stored in the memory of the one of the information processing apparatuses, the additional license count indicating a number of licenses that are additionally assigned, and transmit the additional license count to the first started information processing apparatus and an information processing apparatus that was started immediately after the one of the information processing apparatuses in the startup order; and upon receiving an additional license count from another of the information processing apparatuses, add the received additional license count to the assigned license count stored in the memory of the one of the information processing apparatuses, and transmit the received additional license count to the information processing apparatus that was started immediately after the one of the information processing apparatuses in the startup order; and
wherein the processor of the first started information processing apparatus is configured to, upon receiving the additional license count from the one of the information processing apparatuses, add the received additional license count to an assigned license count stored in the memory of the first started information processing apparatus.

2. The information processing system according to claim 1,
wherein the processor of the first started information processing apparatus is configured to: when a license count obtained by adding the additional license count received from the one of the information processing apparatuses excluding the first started information processing apparatus in the startup order to the assigned license count stored in the memory of the first started information processing apparatus exceeds an owned license count stored in the memory of the first started information processing apparatus, the owned license count indicating a number of licenses that are owned, obtain a total value of assigned license counts of the respective plurality of information processing apparatuses; update the assigned license count stored in the first started information processing apparatus to the total value; and when a license count obtained by adding the received additional license count to the updated assigned license count is equal to or less than the owned license count, transmit a permission for license assignment to the one of the information processing apparatuses; and
wherein the processor of the one of the information processing apparatuses excluding the first started information processing apparatus is configured to, upon receiving from the first started information processing apparatus the permission for license assignment in response to the additional license count transmitted to the first started information processing apparatus, add the additional license count to the assigned license count stored in the memory of the one of the information processing apparatuses.

3. The information processing system according to claim 1,
wherein the processor of an intermediate one of the information processing apparatuses excluding the first started information processing apparatus in the startup order and a last started information processing apparatus in the startup order is configured to, upon removing one or more assigned licenses from the intermediate information processing apparatus, subtract a removed license count from each of an assigned license count and a used license count stored in the memory of the intermediate information processing apparatus, the removed license count indicating a number of licenses to be removed, the used license count indicating a number of licenses that are used, and transmit the removed license count to the first started information processing apparatus in the startup order;
wherein the processor of the first started information processing apparatus in the startup order is configured to update the assigned license count stored in the memory of the first started information processing apparatus by subtracting the received removed license count from the assigned license count stored in the memory of the first started information processing apparatus, and transmit the updated assigned license count to the last started information processing apparatus in the startup order; and
wherein the processor of the last started information processing apparatus in the startup order is configured to update an assigned license count stored in the memory of the last started information processing apparatus to the received assigned license count.

4. The information processing system according to claim 1,
wherein a processor of an information processing apparatus that is newly added to the plurality of information processing apparatuses is configured to access one of the plurality of information processing apparatuses, obtain an address of the first started information processing apparatus in the startup order from the one of the information processing apparatuses, obtain an address of a last started information processing apparatus in the startup order from the first started information processing apparatus, obtain an assigned license count from the last started information processing apparatus, set the obtained assigned license count in the memory of the newly added information processing apparatus, and transmit an address of the newly added information processing apparatus to the first started information processing apparatus in the startup order; and
wherein the processor of the first started information processing apparatus in the startup order is configured to, upon receiving the address of the newly added information processing apparatus, update an address of the last started information processing apparatus in the startup order stored in the memory of the first started information processing apparatus to the received address.

5. The information processing system according to claim 1,
wherein the processor of an information processing apparatus that has detected a failure of an intermediate information processing apparatus that was started immediately after the information processing apparatus in the startup order is configured to transmit information on an assigned license count stored in the memory of the information processing apparatus to an information processing apparatus that was started immediately after the failed intermediate information processing apparatus in the startup order;
wherein the processor of one of the information processing apparatuses excluding a last started information processing apparatus in the startup order is configured to, upon receiving an assigned license count from an information processing apparatus that was started before the one of the information processing apparatuses, obtain a license count by adding the received assigned license count to a used license count stored in the memory of the one of the information processing apparatuses, the used license count indicating a number of licenses that are used, update an assigned license count stored in the memory of the one of the information processing apparatuses to the obtained license count, and transmit the updated assigned license count to an information processing apparatus that was started immediately after the one of the information processing apparatuses in the startup order;
wherein the processor of the last started information processing apparatus in the startup order is configured to, upon receiving the updated assigned license count from an information processing apparatus that was started immediately before the last started information processing apparatus, obtain a license count by adding the received assigned license count to a used license count stored in the memory of the last started information processing apparatus, update an assigned license count stored in the memory of the last started information processing apparatus to the obtained license count, and transmit the updated assigned license count to the first started information processing apparatus in the startup order; and
wherein the processor of the first started information processing apparatus in the startup order is configured to, upon receiving the assigned license count, update the assigned license count stored in the memory of the first started information processing apparatus to the received assigned license count.

6. The information processing system according to claim 1,
wherein the processor of a newly started information processing apparatus that has detected a failure of a last started information processing apparatus in the startup order is configured to obtain addresses of the information processing apparatuses sequentially in the startup order, starting from the first started information processing apparatus in the startup order, and transmit information indicating the failure of the last started information processing apparatus in the startup order to an information processing apparatus that was started immediately after the first started information processing apparatus in the startup order;
wherein the processor of the first started information processing apparatus in the startup order is configured to transmit an address of a last started information processing apparatus in the startup order stored in the memory of the first started information processing apparatus and an address of an information processing apparatus that was started immediately after the first started information processing apparatus in the startup order in response to a query from the newly started information processing apparatus, and checks a running status of the information processing apparatus that was started immediately after the first started information processing apparatus in the startup order;
wherein the processor of one of the information processing apparatuses whose running status is checked by an information processing apparatus that was started immediately before the one of the information processing apparatuses in the startup order is configured to, based on information on an information processing apparatus that was started immediately after the one of the information processing apparatuses in the startup order stored in the memory of the one of the information processing apparatuses, check a running status of the information processing apparatus that was started immediately after the one of the information processing apparatuses; and
wherein the processor of a second last started information processing apparatus that was started immediately before the last started information processing apparatus in the startup order is configured to, when a running status of the second last information processing apparatus is checked by an information processing apparatus that was started immediately before the second last started information processing apparatus, replace information stored in the second last started information processing apparatus with information stored at a time point when the second last started information processing apparatus was a last started information processing apparatus in the startup order.

7. The information processing system according to claim 1,
wherein the processor of a last started information processing apparatus in the startup order is configured to, when the first started information processing apparatus in the startup order fails, report an assigned license count stored in the memory of the last started information processing apparatus to a second started information processing apparatus in the startup order; and
wherein the processor of the second started information processing apparatus in the startup order is configured to store, in the memory of the second started information processing apparatus, the assigned license count received from the last started information processing apparatus in the startup order.

8. The information processing system according to claim 1, further comprising:
a cloud management apparatus configured to manage a cloud;
wherein the cloud management apparatus creates a master image with a system constructed in advance, the master image being set as a first started information processing apparatus in the startup order, and deploys the master image in a cloud environment upon deploying another information processing apparatus in the cloud environment.

9. The information processing system according to claim 1, wherein the memory stores link information and license management information,
the link information including information on
Current indicating a corresponding one of the information processing apparatuses as a current information processing apparatus,
a startup order indicating addresses of started information processing apparatuses that are accumulated in the startup order,
Head indicating an address of the first started information processing apparatus,
Tail indicating an address of a last started information processing apparatus,
Previous indicating an information processing apparatus that was started immediately before the current information processing apparatus, and
Next indicating an address of an information processing apparatus that was started immediately after the current information processing apparatus, and
the license management information including information on
a software name,
an owned license count, and
an assigned license count.

10. An information processing method comprising:
upon additionally assigning one or more licenses to one of a plurality of information processing apparatuses excluding a first started information processing apparatus in a startup order, the plurality of information processing apparatuses being linked in the startup order based on link information, adding, by a processor, an additional license count to an assigned license count stored in the one of the information processing apparatuses, the additional license count indicating a number of licenses that are additionally assigned, the assigned license count indicating a number of licenses that have already been assigned;
transmitting, by the processor, the additional license count to the first started information processing apparatus and one subsequent information processing apparatus that was started immediately after the one of the information processing apparatuses in the startup order;
in the first started information processing apparatus, adding, by the processor, the received additional license count to an assigned license count stored in the first started information processing apparatus;
in the one subsequent information processing apparatus that was started immediately after the one of the information processing apparatuses, adding, by the processor, the received additional license count to an assigned license count stored in the one subsequent information processing apparatus, and transmitting the received additional license count to another subsequent information processing apparatus that was started immediately after the one subsequent information processing apparatus;
repeating, by the processor, an operation of adding and transmitting the received additional license count until the operation reaches a second last started information processing apparatus in the startup order; and
in a last started information processing apparatus in the startup order, adding, by the processor, the received additional license count to an assigned license count stored in the last started information processing apparatus.
